(19) United States
(12) Patent Application Publication
(10) Pub. No.: US 2026/0080331 A1
(43) Pub. Date: Mar. 19, 2026

(54) SURVEILLANCE APPARATUS AND SYSTEM FOR CHECKOUT LINE MANAGEMENT

(71) Applicant: Toshiba Tec Kabushiki Kaisha, Tokyo (JP)

(72) Inventors: Fumihide NISHIMURA, Yokohama Kanagawa (JP); Suzu KIKUTAKE, Fukuoka Fukuoka (JP); Ichiro FUKUZAWA, Ota Tokyo (JP); Naotake HIRAMATSU, Ota Tokyo (JP)

(21) Appl. No.: 19/233,885

(22) Filed: Jun. 10, 2025

(30) Foreign Application Priority Data
Sep. 13, 2024 (JP) 2024-159202

(51) Int. Cl. G06Q 10/0631; G06Q 20/20; G06V 10/12; G06V 20/52; G06V 40/10

(52) U.S. Cl. CPC G06Q 10/06315; G06Q 20/202; G06V 10/12; G06V 20/52; G06V 40/10

(57) ABSTRACT

According to one embodiment, a surveillance apparatus has a processor, a communication interface, a storage unit, and an output interface connected to an output unit in a checkout waiting area. The processor identifies whether customers are waiting in different lines in the checkout waiting area based on an image of the checkout waiting area, then identifies whether any of a plurality of checkout terminals in a checkout area are available. When a checkout terminal is identified as available, the processor selects one of the different lines when a settlement type available at the checkout terminal corresponds to at least one of the lines at which a customer is waiting. Guidance information is then output to indicate that a customer in the selected line should proceed to the available checkout terminal.

### CROSS-REFERENCE TO RELATED APPLICATION

This application is based upon and claims the benefit of priority from Japanese Patent Application No. 2024-159202, filed Sep. 13, 2024, the entire contents of which are incorporated herein by reference.

### FIELD

Embodiments described herein relate generally to surveillance apparatuses, store settlement systems, and an operating method for such apparatuses and systems for line management for checkout in retail stores and the like.

### BACKGROUND

In recent years, self-service payment machines that allow customers to perform payment operations for purchased commodities themselves have become widespread at large retailers such as supermarkets. Typically, multiple payment machines are installed together inside a payment (checkout) area of the store, and the customers enter the payment space to operate the payment machines to complete a sales transaction. However, there may be different types of payment machines that vary according to the payment methods that can be used by customers. These different types of payment machines may, in some cases, be mixed with one another in the same payment area.

### BRIEF DESCRIPTION OF THE DRAWINGS

FIG. 1 depicts a store system according to an embodiment.

FIG. 2 depicts a positional relationship between a self-service POS terminal and a first camera.

FIG. 3 depicts the correspondence among transition of screens displayed on a touch panel of the self-service POS terminal, the contents of operations performed by a settlement maker, and a terminal status of the self-service POS terminal.

FIG. 4 is a block diagram depicting aspects of the surveillance apparatus.

FIG. 5 depicts aspects of a functional configuration of a processor of a surveillance apparatus.

FIG. 6 depicts aspects of a data structure of a determination table.

FIG. 7 is a flowchart of information processing performed by a processor of a surveillance apparatus in accordance with a terminal surveillance program.

FIG. 8 is a flowchart of information processing performed by a processor of a surveillance apparatus in accordance with a terminal surveillance program.

FIG. 9 is a flowchart of information processing performed by a processor of a surveillance apparatus in accordance with a terminal surveillance program.

FIG. 10 is an example of an image displayed on a monitor.

FIG. 11 is another example of an image displayed on a monitor.

FIG. 12 is another example of an image displayed on a monitor.

FIG. 13 depicts aspects of a functional configuration of a processor of a surveillance apparatus in a second embodiment.

FIG. 14 is a flowchart of information processing performed by a processor of a surveillance apparatus in accordance with a terminal surveillance program in a second embodiment.

FIG. 15 depicts aspects of a functional configuration of a processor of a surveillance apparatus.

FIG. 16 shows an example of line management information.

FIG. 17 depicts aspects of terminal management information.

FIG. 18 depicts aspects of output management information.

FIG. 19 is a flowchart showing an example of payment guidance information output by a surveillance apparatus.

FIG. 20 is a first transition diagram for illustrating lines and guidance for self-service POS terminals.

FIG. 21 is a second transition diagram for illustrating lines and guidance for self-service POS terminals.

FIG. 22 is a third transition diagram for illustrating lines and guidance for self-service POS terminals.

FIG. 23 is a fourth transition diagram for illustrating lines and guidance for self-service POS terminals.

FIG. 24 is a fifth transition diagram for illustrating lines and guidance for self-service POS terminals.

FIG. 25 is a sixth transition diagram for illustrating lines and guidance for self-service POS terminals.

### DETAILED DESCRIPTION

Depending on the layout of payment machines in the payment space, it can be difficult for customers to know which payment machines of appropriate types are presently available. When the store is busy, customers may have to wait even though there are payment machines available that could be used. Furthermore, when multiple types or models of payment machines are mixed in the payment area, customers also need to search for the payment machine types/models that support the customer's preferred payment method(s). As a result, payment machine types/models that support the intended payment method of an arriving customer may remain idle for a while before being found, and other customers with a different preferred payment method may have to wait behind the already waiting customer even though a machine they could use is otherwise available. As such, there is a concern that the overall operating efficiency of the available payment machines decreases and store throughput is hindered.

In general, according to one embodiment, there is provided a surveillance apparatus, a surveillance system, and a method for such apparatuses and systems that provides guidance information to customers waiting in line for checkout processing and the like in retail stores and the like. Such embodiments represent a technological improvement over existing systems by providing an increase in the usage efficiency of an available mix of payment (checkout) machines that may be capable of handling different payment types for waiting customers.

According to one embodiment, a surveillance apparatus for a retail store system or the like includes a communication interface, a storage unit, an output interface connectable to an output unit in a checkout waiting area, a first camera interface connectable to a first camera, a second camera interface connectable to a second camera, and a processor. The processor is configured to: identify whether customers are waiting in any of a plurality of different lines established in the checkout waiting area for different settlement types based on an image of the checkout waiting area received via the second interface from the second camera; identify whether any of a plurality of checkout terminals in a checkout area are available based on status notifications received via the communication interface for the plurality of checkout terminals and images received via the first interface from a first camera associated with each of the plurality of checkout terminals; when a checkout terminal is identified as available, select a line of the plurality of different lines when preset information stored in the storage unit indicates a settlement type available at the identified checkout terminal corresponds to the settlement type for which the line is established; and output guidance information via the output interface to indicate a customer in the selected line should proceed to the checkout terminal identified as available.

Certain example embodiments will be described below with reference to the drawings. Note that the depicted aspects in the drawings such as scaling, dimensions, and relative positioning of components in the drawings may differ from those of some implemented embodiments and may, in general, be varied as appropriate unless otherwise stated. In the drawings, some aspects may have been omitted or rearranged for the purposes of explanatory convenience or the like. The specifically depicted example aspects may be varied or altered as appropriate in other embodiments.

The present disclosure describes as an example embodiment a surveillance apparatus that watches over multiple full-self-service-type settlement terminals being operated by customers to perform all the checkout operations from registering commodities for purchase to settlement (payment). Such terminals may be called self-service POS (point of sales) terminals in some contexts.

### First Embodiment

### Description of Store System

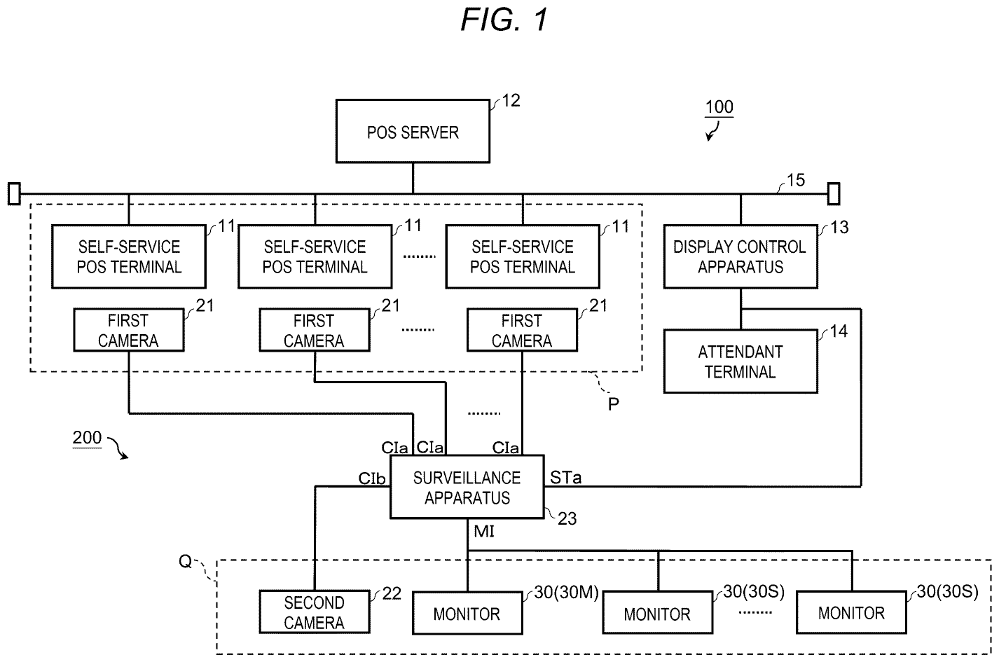

FIG. 1 shows a store system established in a store such as a supermarket with self-service POS terminals. The overall store system includes a self-service POS system 100 and a terminal surveillance system 200.

The self-service POS system 100 comprises multiple self-service POS terminals 11, a POS server 12, a display control apparatus 13, an attendant terminal 14, and a communication network 15. In the self-service POS system 100, the self-service POS terminals 11, the POS server 12, and the display control apparatus 13 are each connected to the communication network 15. The attendant terminal 14 is coupled to the display control apparatus 13. The communication network 15 is typically a LAN (local area network). The LAN may be a wired LAN or a wireless LAN.

The self-service POS terminals 11 in this example are each a full-self-service settlement type terminal that allows a customer to perform all checkout operations from registering commodities to settlement by himself/herself. The customer may be called a settlement maker in this context of using a self-service POS terminal 11. The multiple self-service POS terminals 11 are installed in a payment area P separated from a sales floor where commodities are displayed. A settlement maker who has selected commodities to be purchased from the sales floor eventually enters the payment area P and operates an available self-service POS terminal 11 to complete the checkout operations from registering the commodities to settlement (payment) to complete the sales transaction.

The POS server 12 is a server computer that collects and tallies up data on each commodity sold at the store from the self-service POS terminals 11, and manages the store's sales, product inventory, and the like. To achieve this type of management, the POS server 12 has stored therein a commodity master and a sales master. The commodity master is a database in which data about the unit price, commodity name, and other items for each commodity sold at the store is associated with a commodity code that distinguishes the particular commodity from others. The sales master is a database in which data, such as the received quantity, the sold quantity, the sales amount, and other items for each commodity (commodity code), and accumulated store sales data (e.g., sales data for all commodities sold at the store) are tallied up, for example, on a per business day basis.

The display control apparatus 13 is a controller that generates an image for each of the self-service POS terminals 11 based on a data signal output from the self-service POS terminals 11. The generated images are provided for display at the attendant terminal 14. The attendant terminal 14 is a terminal at which a store clerk (called an attendant) monitors the state of each of the self-service POS terminals 11. The attendant terminal 14 has, for example, a display such as a liquid crystal display or an organic EL display. The display screen of the attendant terminal 14 is typically divided into multiple segments (or regions) in which images related to each of the different self-service POS terminals 11 are respectively displayed.

The terminal surveillance system 200 includes multiple first cameras 21, one or more second cameras 22, a surveillance apparatus 23, and multiple monitors 30. The first cameras 21 are provided in the payment area P to be in correspondence with each of the self-service POS terminals 11 on a one-to-one basis. The first cameras 21 capture an image of a settlement maker who is operating the self-service POS terminal 11 corresponding to the first camera 21.

A second camera 22 is provided to monitor a waiting area Q, where customers wait to enter the payment area P for settlement. The second camera 22 captures images of the customers waiting in the waiting area Q.

The surveillance apparatus 23 monitors the availability of the self-service POS terminals 11 based on terminal statuses STa output from the display control apparatus 13 and image data CIa from the first cameras 21. The surveillance apparatus 23 operates to generate image data MI indicating the availability of the self-service POS terminals 11. The image data MI is generated based in part on image data CIb captured by a second camera 22. The surveillance apparatus 23 outputs image data MI to the monitors 30 installed in the waiting area Q.

A terminal status STa is status data from a particular self-service POS terminal 11 indicating that the terminal is either in an “idle” state (that is, in a waiting state, such as before an input operation from a settlement maker is received at the self-service POS terminal 11) or an “in-operation” state (that is, in active use). The self-service POS terminals 11 each track their respective terminal status STa in an internal memory or the like. The display control apparatus 13 receives the terminal status STa from each of the self-service POS terminals 11 and provides these to the surveillance apparatus 23. The surveillance apparatus 23 may also be called a settlement terminal surveillance apparatus.

The monitors 30 include a primary monitor 30M, which displays overall guidance, and secondary monitors 30S installed to match with waiting customer lines set on a payment method type basis. Note that, in some examples, the display region of a single secondary monitor 30S may be divided into multiple display segment regions for the different waiting lines (or payment method types).

### Description of Self-Service POS Terminals and First Cameras

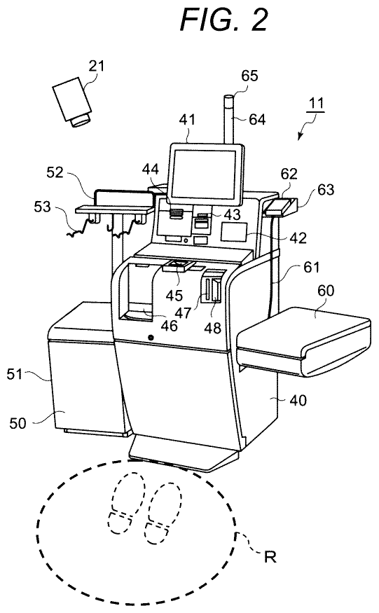

FIG. 2 shows the positional relationship between each of the self-service POS terminals 11 and the corresponding first camera 21. The exterior configuration of the self-service POS terminal 11 will first be described. Note that there are various models of self-service POS terminals 11, and that FIG. 2 shows an example of the exterior configuration of one of the various models of self-service POS terminals 11.

The self-service POS terminal 11 includes a body 40 installed at the floor surface and a bagging stand 50 installed next to the body 40. The body 40 has a touch panel 41 attached to an upper portion of the body 40. The touch panel 41 is configured with a display and a touch sensor. The display is a device that displays various screens to show the screens to an operator who operates the self-service POS terminal 11. The touch sensor is a device that detects a touch input made to any of the screens by the operator. The operator of the self-service POS terminal 11 is usually a customer making a transaction settlement.

The body 40 has a basket stand 60 provided at a central portion of the side surface of the body 40 that is opposite the side on which the bagging stand 50 is installed. The basket stand 60 is intended for a settlement maker to place a basket or the like containing commodities being purchased. The settlement maker operates the self-service POS terminal 11 while standing in an operation region R in front of the body 40 (see FIG. 2) so as to be able to see the screen of the touch panel 41. Therefore, when viewed from the settlement maker standing in the operation region R, the basket stand 60 is on the right side of the body 40, and the bagging stand 50 is on the left side thereof. It is assumed in the following description that the side where the operation region R is located is a front side, that the side where the bagging stand 50 is installed is a left side, and that the side where the basket stand 60 is installed is a right side.

The body 40 has the following portions formed at the front surface thereof: a scanner reading window 42; a card insertion slot 43; a receipt issuing slot 44; a coin insertion slot 45; a coin dispensing slot 46; a bill insertion slot 47; and a bill dispensing slot 48. A communication cable 61 extends outward from the right side surface of the body 40, and a reader/writer 62 for electronic money media is coupled to the communication cable 61. The reader/writer 62 is placed on a placement stand 63 provided at an upper portion of the right side surface of the body 40.

The body 40 has a display pole 64 attached to the upper surface of the body 40. The display pole 64 has a rotary beacon light 65, which selectively emits light, for example, green or red light, attached to the display pole 64. The display pole 64 displays the current state of the self-service POS terminal 11 by the lighting state of the rotary beacon light 65. For example, a lamp color or the like. For example, the state may be standby, in-operation (in-use), calling (store clerk requested), error, and other states distinguished by the color or the like of the light emitted from the rotary beacon light 65.

The bagging stand 50 has a structure in which a bag holder 52 is attached to a portion above a housing 51. The bag holder 52 includes a pair of holding arms 53, which hold a plastic bag provided in the store or a shopping bag brought by the settlement maker, what is called a reusable bag, or the like.

For a self-service POS terminal 11 having the exterior configuration described above, the first camera 21 is provided at a position where the first camera 21 can capture, from above, an image of the settlement maker standing in the operation region R of the self-service POS terminal 11 and facing the body 40 and using the bagging stand 50, the basket stand 60, and other parts.

Note that the settlement maker standing in the operation region R generally first places a basket containing commodities to be purchased on the basket stand 60. The settlement maker then operates the touch panel 41 in accordance with guidance displayed on the touch panel 41 to declare the start of use of the self-service POS terminal 11.

The settlement maker then picks up the commodities one by one from the basket on the basket stand 60. When one of the commodities to be purchased has a bar code attached thereto, the settlement maker holds the bar code in front of the reading window 42 to have the scanner read the bar code, so that the commodity is registered. When one of the commodities to be purchased does not have a barcode attached thereto, the settlement maker operates the touch panel 41 to select the commodity to be purchased from a list of commodities to register the commodity. The settlement maker then puts the commodities that have been registered in the plastic bag or the reusable bag.

After registering all the commodities, the settlement maker operates the touch panel 41 to perform a closing operation, and subsequently selects a payment method. For example, after selecting cash payment, the settlement maker inserts bills or coins into the bill insertion slot 47 or coin insertion slot 45, and takes out the change paid out via the bill dispensing slot 48 or coin dispensing slot 46. For example, after selecting electronic money payment, which is one type of cashless settlement, the settlement maker holds an electronic money medium in front of the reader/writer 62. For example, after selecting credit card payment, which is one type of cashless settlement, the settlement maker inserts a credit card into the card insertion slot 43. When the settlement has been completed through any of the available payment options, the settlement maker receives a receipt issued via the receipt issuing slot 44, and then leaves the store with the plastic bag or the reusable bag removed from the holding arms 53. The first camera 21 is attached at a position where it can capture an image of the operations of the settlement maker performed at the self-service POS terminal 11.

### Description of Status Data

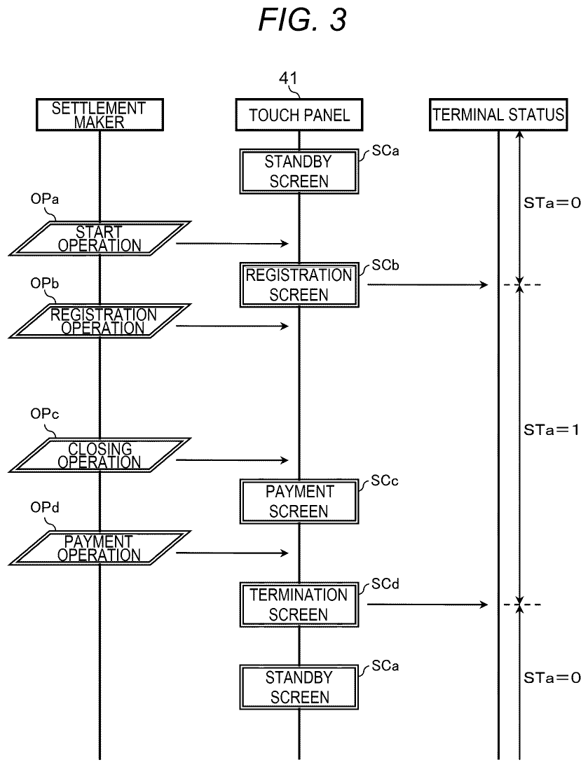

FIG. 3 is a sequence diagram showing the correspondence among transition of the screens displayed on the touch panel 41 of the self-service POS terminal 11, the contents of the operations performed by the settlement maker, and data on the status (terminal status Sta) of the self-service POS terminal 11. When the terminal status STa is “0”, that is, when the self-service POS terminal 11 is in the idle state, a standby screen SCa is displayed on the touch panel 41. The standby screen SCa is a screen via which the self-service POS terminal 11 waits for acceptance of an operation input from the settlement maker.

In this state, when the settlement maker performs a start operation OPa at the self-service POS terminal 11, the screen on the touch panel 41 switches to a registration screen SCb. The registration screen SCb is a screen that displays data such as the name, the price, and other factors of the purchased commodity having been sold and registered. At this point in time, the state of the self-service POS terminal 11 transitions from the idle state to an in-operation state after accepting the operation input. That is, the terminal status STa transitions from “0” to “1”.

The settlement maker then performs a registration operation OPb of registering the commodities to be purchased at the self-service POS terminal 11. After completing the registration operation, the settlement maker performs a closing operation OPc. In response to the closing operation OPc, the screen on the touch panel 41 transitions to a payment screen SCc. The payment screen is a screen via which payment for the total price of the purchased commodities is accepted. The settlement maker performs a payment operation OPd of paying the total price at the self-service POS terminal 11.

When the payment of the total price is completed, the screen on the touch panel 41 transitions to a termination screen SCd. The termination screen SCd is a screen that notifies the settlement maker that the settlement is completed. At this point in time, the state of the self-service POS terminal 11 returns from the in-operation state to the idle state. That is, the terminal status STa transitions from “1” to “0”. Thereafter, after some preset time has elapsed, the screen on the touch panel 41 returns to the standby screen SCa. The self-service POS terminal 11 then waits for the start operation OPa performed by a next settlement maker.

As described above, the terminal status STa is “0” after the start operation OPa is performed by the settlement maker but before the screen on the touch panel 41 transitions to the registration screen SCb. When the screen transitions to the registration screen SCb, the terminal status STa becomes “1”, and the terminal status STa remains “1” after the settlement maker performs the payment operation OPd but before the screen on the touch panel 41 transitions to the termination screen SCd. When the screen transitions to the termination screen SCd, the terminal status STa becomes “0”. That is, the self-service POS terminal 11 is in the idle state until the screen on the touch panel 41 transitions from the standby screen SCa to the registration screen SCb. The self-service POS terminal 11 is in the in-operation state, in which the self-service POS terminal 11 accepts an operation input from the settlement maker, until the screen on the touch panel 41 transitions from the registration screen SCb to the termination screen SCd.

### Description of Configuration of Surveillance Apparatus

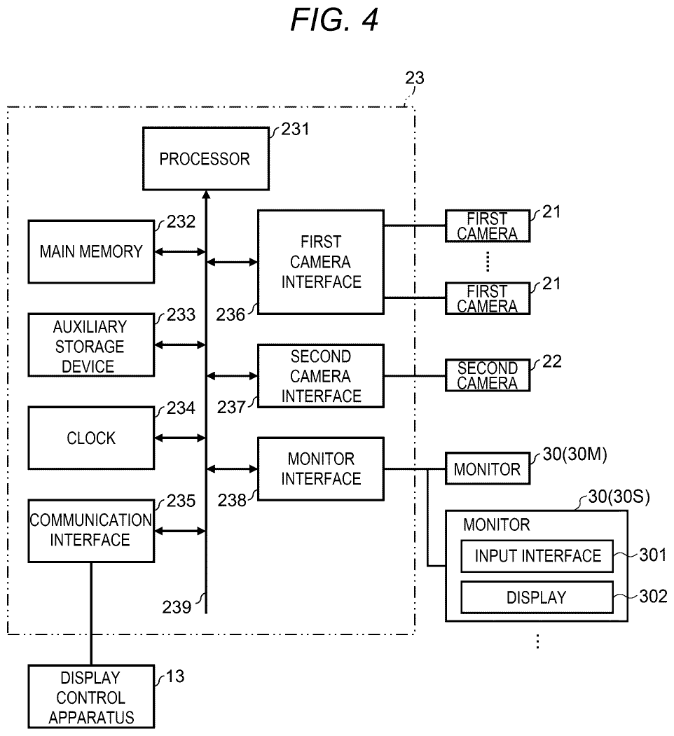

FIG. 4 is a block diagram showing a key-part circuit configuration of the surveillance apparatus 23. The surveillance apparatus 23 includes circuit parts such as a processor 231, a main memory 232, an auxiliary storage device 233, a clock 234, a communication interface 235, a first camera interface 236, a second camera interface 237, and a monitor interface 238, and a system transmission path 239. The system transmission path 239 includes an address bus, a data bus, a control signal line, and the like. The surveillance apparatus 23, in which the circuit parts are coupled to the system transmission path 239, constitutes a computer.

The processor 231 realizes various functions of the surveillance apparatus 23 in accordance with an operating system and/or an application program (application software). The processor 231 is, for example, a CPU (central processing unit). The processor 231 may, for example, be a micro-processing unit (MPU), a system on a chip (SoC), a digital signal processor (DSP), a graphics processing unit (GPU), an application specific integrated circuit (ASIC), a programmable logic device (PLD), or a field-programmable gate array (FPGA). In some examples, processor 231 may be a combination of two or more of the devices described above.

The main memory 232 includes a nonvolatile memory region and a volatile memory region. The main memory 232 stores the operating system or the application program in the nonvolatile memory region. The main memory 232 stores in some cases data necessary for the processor 231 to carry out processes for controlling the circuit parts in the nonvolatile or volatile memory region. The main memory 232 uses the volatile memory region as a work area where data is overwritten by the processor 231 as appropriate. The nonvolatile memory region is, for example, a read only memory (ROM). The volatile memory region is, for example, a random access memory (RAM).

The auxiliary storage device 233 may be an electric erasable programmable read-only memory (EEPROM), a hard disk drive (HDD), or a solid-state drive (SSD). The auxiliary storage device 233 saves, for example, data used by the processor 231 to carry out the various processes, or data created in the processes carried out by the processor 231. The auxiliary storage device 233 further store the application program described above in some cases.

The clock 234 keeps track of the date and time. The surveillance apparatus 23 acquires the date and time kept track by the clock 234 as the current date and time.

The communication interface 235 connects with the display control apparatus 13. The communication interface 235 captures the terminal status STa of each of the self-service POS terminals 11 from the display control apparatus 13. The first camera interface 236 connects with the multiple first cameras 21. The first camera interface 236 captures the image data CIa captured by each of the first cameras 21. The second camera interface 237 connects with the second camera 22. The second camera interface 237 captures the image data CIb captured by the second camera 22. The monitor interface 238 connects with the monitors 30. The monitor interface 238 outputs the image data MI generated by the surveillance apparatus 23 to the monitors 30.

The monitors 30 each include an input interface 301 and a display 302. The input interface 301 receives a video signal output from the monitor interface 238. The display 302 displays a video based on the video signal input from the input interface 301.

### Description of Functions of Surveillance Apparatus

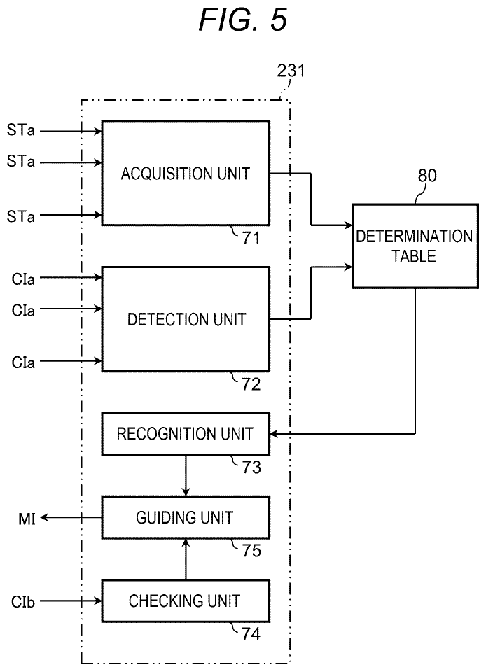

FIG. 5 is a diagrammatic view showing a primary functional configuration of the processor 231 of the surveillance apparatus 23. The processor 231 has functions as an acquisition unit 71, a detection unit 72, a recognition unit 73, a checking unit 74, and a guiding unit 75.

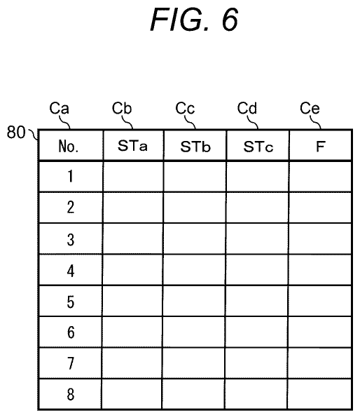

The surveillance apparatus 23 further includes a determination table 80. The determination table 80 is a data table having a first column Ca, a second column Cb, a third column Cc, a fourth column Cd, and a fifth column Ce, as shown in FIG. 6. The determination table 80 is saved, for example, in the auxiliary storage device 233.

Terminal numbers No. are written in the first column Ca. The terminal numbers No. are consecutive numbers assigned to the self-service POS terminals 11 and starting from “1” to individually identify the self-service POS terminals 11. Note that FIG. 6 shows an example of the determination table 80 for the self-service POS system 100 including eight self-service POS terminals 11 to which terminal numbers No. from “1” to “8” are assigned.

The terminal status STa is written in the second column Cb. The terminal status STa is the status data acquired from the self-service POS terminal 11 of the corresponding terminal number No. The terminal status STa indicates whether the self-service POS terminal 11 is in the idle state or the in-operation state. In the present embodiment, when a self-service POS terminal 11 is in the idle state, the terminal status STa is set to “0”. When a self-service POS terminal 11 is in the in-operation state, the terminal status STa is set to “1”.

A person status STb is written in the third column Cc. The person status STb is data for identifying whether or not a person is present in the operation region R of a particular self-service POS terminal 11 (terminal number No). In the present embodiment, when no person is present in the operation region R, the person status STb is set to “0”. When a person is present in the operation region R, the person status STb is set to “1”.

An availability status STc is written in the fourth column Cd. The availability status STc is data indicating the availability of the self-service POS terminal 11 by corresponding terminal number No. In the present embodiment, when the self-service POS terminal 11 is available, the availability status STc for the self-service POS terminal 11 (terminal number No.) is set to “0”. When the self-service POS terminal 11 is not available, the availability status STc is set to “1”.

A guide flag F is written in the fifth column Ce. The guide flag F is 1-bit data for identifying whether or not a settlement maker has been guided to a particular self-service POS terminal 11 (terminal number No.). In the present embodiment, the guide flag F indicating that a settlement maker has not been guided to the self-service POS terminal 11 (a terminal number No.) is set to “0”. The guide flag F indicating that a settlement maker has been guided to the self-service POS terminal 11 (terminal number No.) is set to “1”.

The description will be made with reference to FIG. 5 again.

The acquisition unit 71 is the function of acquiring the status data indicating whether any of the self-service POS terminals 11 is in the idle state or in the in-operation state. The status data of each of the self-service POS terminals 11, that is, the terminal status STa, is provided from the display control apparatus 13 to the surveillance apparatus 23, as described above. The acquisition unit 71 acquires the terminal status STa of each of the self-service POS terminals 11 from the display control apparatus 13 via the communication interface 235. The acquisition unit 71 then updates the terminal status STa in the determination table 80. That is, when there is a self-service POS terminal 11 in the idle state, the terminal status STa corresponding to the this the self-service POS terminal 11 is set to “0”. When there is a self-service POS terminal 11 in the in-operation state, the terminal status STa corresponding to this self-service POS terminal 11 is set to “1”.

The detection unit 72 provides the function of detecting a person who is present in the region where a settlement maker operates a self-service POS terminal 11. The detection unit 72 analyzes the image data CIa captured by the first camera 21 to determine whether the image data CIa contains such a person. When the image data CIa contains such a person, the detection unit 72 recognizes that a person is present in the operation region R of the self-service POS terminal 11 corresponding to the first camera 21. The detection unit 72 updates the person status STb in the determination table 80 based on the result of the detection. That is, when there is a self-service POS terminal 11 where no person is detected in the operation region R, the person status STb. of this self-service POS terminal 11 is set to “0”. When there is a self-service POS terminal 11 where a person is detected in the operation region R, the person status STb for this self-service POS terminal 11 is set to “1”.

The recognition unit 73 provides the function of recognizing that a self-service POS terminal 11 is available when the acquisition unit 71 acquires the status data indicating that the self-service POS terminal 11 is in the idle state and the detection unit 72 has detected no person. That is, the recognition unit 73 recognizes a self-service POS terminal 11 having the terminal status STa being “0” and the person status STb being “0” in the determination table 80 as an available terminal. The recognition unit 73 recognizes a self-service POS terminal 11 and having the terminal status STa being “1” or the person status STb being “1” in the determination table 80 as an unavailable terminal. The recognition unit 73 sets the availability status STc a self-service POS terminal 11 (identified by terminal number No.) having been recognized as an available terminal to “0”. The recognition unit 73 sets the availability status STc of a self-service POS terminal 11 having been recognized as an unavailable terminal to “1”.

The checking unit 74 provides the function of checking whether or not there is a settlement maker waiting to use a self-service POS terminal 11. The checking unit 74 analyzes the image data CIb on an image of the waiting area Q captured by the second camera 22 to determine whether the image data CIb contains a person. When the image data CIb contains one or more persons, the checking unit 74 determines that there is a settlement maker waiting to use a self-service POS terminal 11. When the image data CIb contains no person, the checking unit 74 determines that there is no settlement maker waiting to use a self-service POS terminal 11.

The guiding unit 75 provides the function of guiding the settlement maker to an available self-service POS terminal 11 based on the result of the recognition made by the recognition unit 73. Specifically, the guiding unit 75 provides guidance by displaying on the monitors 30 information for guiding the settlement maker to an available self-service POS terminal 11. The guiding unit 75 changes guidance information displayed on the monitors 30 when the checking unit 74 indicates that there is a settlement maker waiting to use a self-service POS terminal 11 and when there is no such a settlement maker.

The functions of the acquisition unit 71, the detection unit 72, the recognition unit 73, the checking unit 74, and the guiding unit 75 described above are all realized by information processing performed by the processor 231 in accordance with a terminal surveillance program.

The terminal surveillance program is one type of the application program stored in the main memory 232 or the auxiliary storage device 233. A method for installing the terminal surveillance program in the main memory 232 or the auxiliary storage device 233 is not limited to a specific method. The terminal surveillance program can be recorded on a removable recording medium, or can be distributed by communication via a network and installed in the main memory 232 or the auxiliary storage device 233. The recording medium may be any type of medium that can store a program and is readable by an apparatus, such as a CD-ROM and a memory card.

### Description of Operation of Surveillance Apparatus

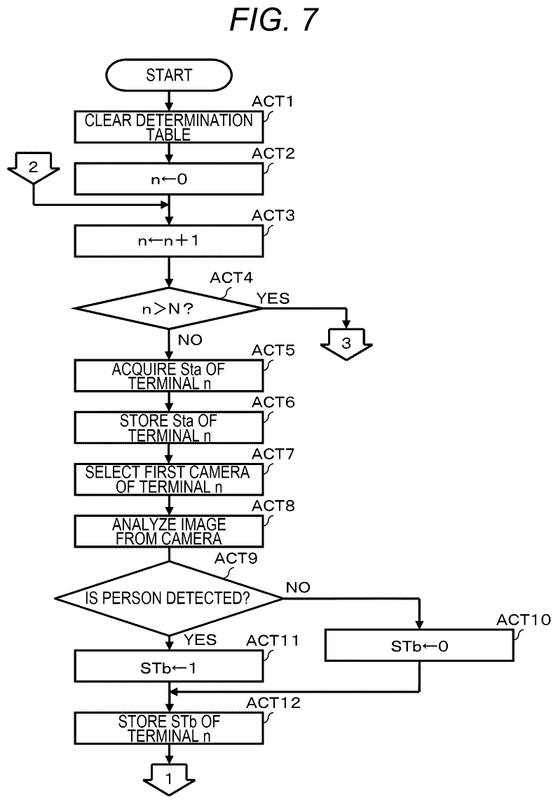

FIGS. 7 to 9 are flowcharts showing the procedure of the information processing performed by the processor 231 of the surveillance apparatus 23 in accordance with instructions of the terminal surveillance program. Primary operations of the surveillance apparatus 23 will be described below with reference to FIGS. 7 to 9. The specific example operations described below are presented by way of explanation. In general, the described procedures and contents of the information processing can be changed as appropriate as long as substantially the same effects and advantages can be achieved.

The processor 231 of the surveillance apparatus 23 starts the information processing according to the procedures shown in the flowcharts of FIGS. 7 to 9 when the store opens, for example. The processor 231 first clears the determination table 80 as ACT 1 (FIG. 7). As a result, the data written in the second column Cb, the third column Cc, the fourth column Cd, and the fifth column Ce of the determination table 80, that is, the terminal status STa, the person status STb, the availability status STc, and the guide flag F all become “0”.

Having cleared the determination table 80, the processor 231 proceeds to ACT 2. The processor 231 resets an “up counter n” value to “0” as ACT 2. The processor 231 then increase the up counter n value by “1” as ACT 3. The processor 231 then checks whether or not the up counter n has exceeded a threshold N as ACT 4. The threshold N is the number of the self-service POS terminals 11 provided in the self-service POS system 100. That is, in the case of the surveillance apparatus 23 of the self-service POS system 100 including eight self-service POS terminals 11 to which the terminal numbers No. from “1” to “8” are assigned, the threshold N is “8”.

When the up counter n has not yet exceeded the threshold N, the processor 231 proceeds to ACT 5. The processor 231 acquires as ACT 5 the terminal status STa of the self-service POS terminal 11 having a terminal number n from the display control apparatus 13. The symbol “n” of the terminal number n corresponds to the value of the up counter n. The processor 231 writes, as ACT 6, the terminal status STa of the self-service POS terminal 11 that has been acquired from the display control apparatus 13 in the second column Cb corresponding to the terminal number n in the determination table 80.

Having completed the processes in ACT 5 and ACT 6, the processor 231 proceeds to ACT 7. The processor 231 selects, as ACT 7, the first camera 21 assigned to the self-service POS terminal 11 having the terminal number n. The processor 231 then captures and analyzes, as ACT 8, the image data CIa captured by the selected first camera 21. The processor 231 checks, as ACT 9, whether or not a person is detected from the image data CIa.

When no person is detected, the processor 231 proceeds to ACT 10. The processor 231 sets the person status STb to “0” as ACT 10. In contrast, when a person is detected, the processor 231 proceeds to ACT 11. The processor 231 sets the person status STb to “1” as ACT 11.

Having completed the process in ACT 10 or ACT 11, the processor 231 proceeds to ACT 12. As ACT 12, the processor 231 writes the person status STb acquired in the process in ACT 10 or ACT 11 in the third column Cc corresponding to the terminal number n in the determination table 80.

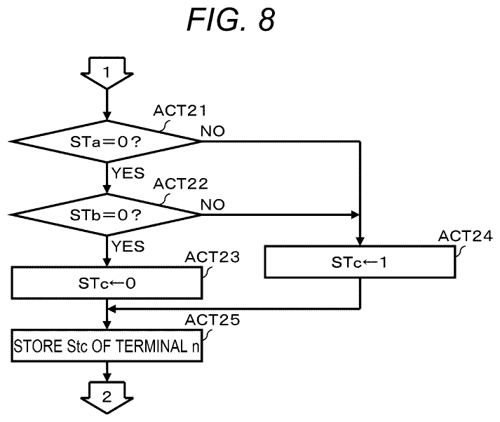

Having written the person status STb in the determination table 80, the processor 231 proceeds to ACT 21 in FIG. 8. The processor 231 checks the terminal status STa corresponding to the terminal number n as ACT 21. When the terminal status STa is “0”, the processor 231 proceeds to ACT 22. The processor 231 checks the person status STb corresponding to the terminal number n as ACT 22. When the person status STb is also “0”, the processor 231 proceeds to ACT 23. The processor 231 sets the availability status STc to “0” as ACT 23.

On the other hand, when the terminal status STa is “1” in ACT 21, or when the person status STb is “1” in ACT 22, the processor 231 proceeds to ACT 4. The processor 231 sets the availability status STc to “1” as ACT 24.

Having completed the process in ACT 23 or ACT 24, the processor 231 proceeds to ACT 25. As ACT 25, the processor 231 writes the availability status STc acquired in the process in ACT 23 or ACT 24 in the column Cc corresponding to the terminal number n in the determination table 80.

The processor 231 thus sets the availability status STc to “0” for each self-service POS terminal 11 having the terminal status STa and person status STb both being “0”. That is, the processor 231 recognizes that a self-service POS terminal 11 is available. In contrast, the processor 231 sets the availability status STc to “1” for a self-service POS terminal 11 having the terminal status STa and/or the person status STb being “1”. That is, the processor 231 recognizes that the self-service POS terminal 11 is unavailable.

Having completed the process in ACT 25, the processor 231 returns to ACT 3 in FIG. 7. The processor 231 then carries out the processes in ACT 3 and the following ACTs in the same manner described above. That is, each time the processor 231 counts up the up counter n by “1”, the processor 231 acquires the terminal status STa identified by the self-service POS terminal 11 having the terminal number n and writes the terminal status STa in the determination table 80. The processor 231 analyzes whether or not the image data CIa from the first camera 21 corresponding to the self-service POS terminal 11 having the terminal number n contains a person, acquires the person status STb, and writes the person status STb in the determination table 80. The processor 231 then determines the availability status STc based on the connection between the terminal status STa and the person status STb, and writes the availability status STc in the determination table 80. The processor 231 repeatedly carries out the processes described above until the up counter n exceeds the threshold N.

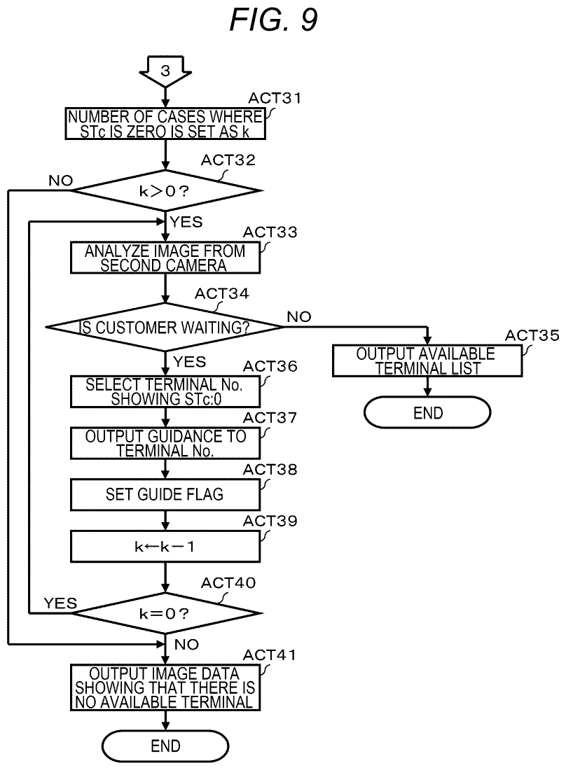

When the processor 231, in ACT 4, the up counter n has exceeded the threshold N, the processor 231 proceeds to ACT 31 in FIG. 9. In ACT 31, the processor 231 searches the determination table 80 to acquire the number of cases where the availability status STc is “0”, and sets the number as the initial value of a “down counter k.” That is, the value of the down counter k is the number of self-service POS terminals 11 that have been recognized as being available based on the relationship between the terminal status STa and the person status STb.

As ACT 32, the processor 231 checks whether or not the down counter k value is greater than “0”. When the down counter k is “0”, that is, when the number of self-service POS terminals 11 recognized as being available is zero, the processor 231 skips the processes in ACT 33 to ACT 40 and proceeds to ACT 41. In ACT 41, the processor 231 generates image data MIa indicating that there is no available self-service POS terminal 11, and outputs the image data MIa to the monitors 30.

In contrast, when the down counter k value is greater than “0” in ACT 32, that is, when one or more self-service POS terminals 11 are recognized as being available, the processor 231 proceeds to ACT 33. As ACT 33, the processor 231 acquires and analyzes the image data CIb from the second camera 22. The processor 231 checks, as ACT 34, whether or not a person is detected from the image data CIb, that is, whether or not a customer waiting for settlement is present in the waiting area Q.

When no person is detected from the image data CIb, that is, when no customer waiting for settlement is present in the waiting area Q, the processor 231 proceeds to ACT 35. The processor 231 generates image data MIb on a list that allows identification of available self-service POS terminals 11 and unavailable self-service POS terminals 11, and outputs the image data MIb to the monitors 30 as ACT 35.

On the other hand, when a person is detected from the image data CIb in ACT 34, that is, when a customer waiting for settlement is present in the waiting area Q, the processor 231 proceeds to ACT 36. The processor 231 selects a terminal number (a self-service POS terminal 11) showing the availability status STc being “0” and the guide flag F being “0” in ACT 36. The processor 231 creates image data MIc for guiding the customer waiting for settlement to the particular self-service POS terminal 11 identified as available, and outputs the image data MIc to the monitors 30 as ACT 37.

The processor 231 then sets the guide flag F corresponding to the terminal number of this particular self-service terminal 11 in the determination table 80 to “1” as ACT 38. The processor 231 reduces the down counter k by “1” as ACT 39. The processor 231 then checks, as ACT 40, whether or not the count (value) of the down counter k has reached “0”.

When the down counter k value is greater than “0”, the processor 231 returns to ACT 33. The processor 231 then carries out the processes in ACT 33 and subsequent processes in the same manner described above. That is, the processor 231 checks based on the image data CIb from the second camera 22 whether a customer waiting for settlement is present in the waiting area Q. Thereafter, when there is a customer waiting for payment, the processor 231 selects a terminal number No. (a self-service POS terminal 11) showing the availability status STc being “0” and the guide flag F being “0”, and outputs the image data MIc for guiding the customer waiting for settlement to this selected self-service POS terminal 11 (terminal number No.) to the monitors 30.

The processor 231 repeatedly carries out the processes in ACT 33 to ACT 40 until the processor 231 finds that no customer waiting for settlement is present in the waiting area Q or until the down counter k becomes “0”. When the processor 231 determines in ACT 34 that no customer waiting for settlement is present in the waiting area Q before the down counter k value becomes “0”, the processor 231 proceeds to ACT 35. That is, the processor 231 generates the image data MIb on the list that allows identification of available self-service POS terminals 11 and unavailable self-service POS terminals 11, and outputs the image data MIb to the monitors 30.

On the other hand, when a customer waiting for settlement is present in the waiting area Q and the down counter k reaches “0”, the processor 231 proceeds to ACT 41. That is, the processor 231 generates the image data MIa indicating that there is no available self-service POS terminal 11, and outputs the image data MIa to the monitors 30.

When the processor 231 outputs the image data MIb or the image data MIc to the monitors 30 in ACT 35, the processor 231 may temporarily terminate the information processing performed in accordance with the procedure shown in the flowcharts of FIGS. 7 to 9. The processor 231 may then resume the information processing starting from ACT 1 in accordance with the procedure shown in the flowcharts of FIGS. 7 to 9.

The processor 231 realizes the function as the acquisition unit 71 by carrying out the processes in ACT 3 to ACT 6. The processor 231 realizes the function as the detection unit 72 by carrying out the processes in ACT 7 to ACT 12. The processor 231 realizes the function as the recognition unit 73 by carrying out the processes in ACT 21 to ACT 25. The processor 231 realizes the function as the checking unit 74 by carrying out the processes in ACT 33 and ACT 34. The processor 231 realizes the function of the guiding unit 75 by carrying out the processes in ACT 35 to ACT 41.

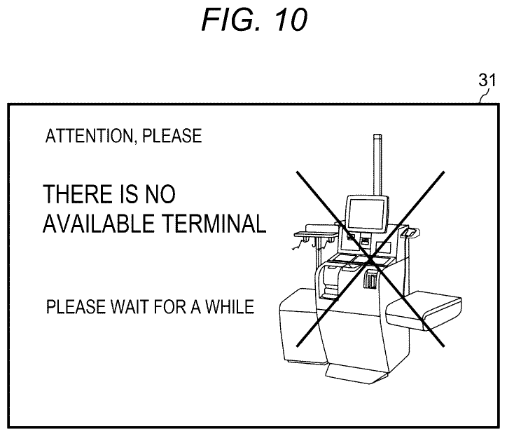

FIG. 10 is an example of an image 31 displayed on the monitors 30 based on the image data MIa. Information indicating that there is no available self-service POS terminal 11 is thus displayed on the monitors 30 having received the image data MIa. The customers can therefore know from the information on the monitors 30 that there is no available self-service POS terminal 11.

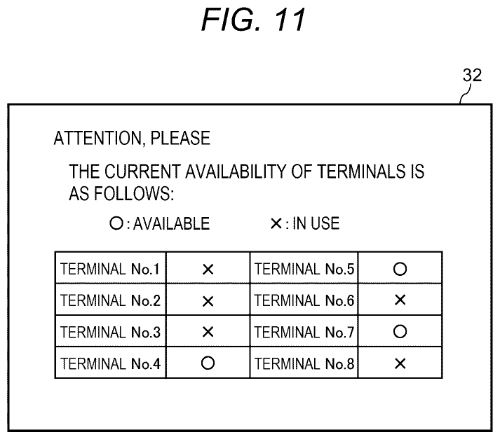

FIG. 11 is an example of an image 32 displayed on the monitors 30 based on the image data MIb. A list that allows identification of available self-service POS terminals 11 and unavailable self-service POS terminals 11 is thus displayed on the monitors 30 having received the image data MIb. Customers near the waiting area Q can therefore easily know from the information on the monitors 30 how many self-service POS terminals 11 are currently available or unavailable.

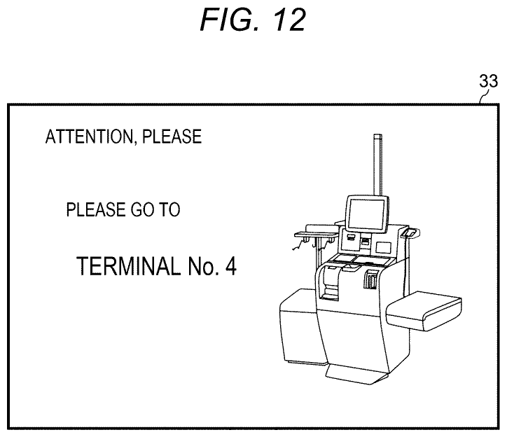

FIG. 12 is an example of an image 33 displayed on the monitors 30 based on the image data MIc. Information that guides a customer waiting for settlement to one available self-service POS terminal 11 is thus displayed on the monitors 30 having received the image data MIc. The first customer in line in the waiting area Q may therefore go to the location in the payment area P where the self-service POS terminal 11 having the specified terminal number is installed based on the information on monitors 30, and make settlement.

### Description of Effects of Surveillance Apparatus

As described above, the surveillance apparatus 23 has provides functions of the acquisition unit 71, the detection unit 72, and the recognition unit 73. These described functions allow the surveillance apparatus 23 to recognize a self-service POS terminal 11 that is in an idle state with no person in its operation region R as being available, and a self-service POS terminal 11 that is in use or has a person in its operation region R as being unavailable. Therefore, even when a settlement maker temporarily leaves the self-service POS terminal 11 in the middle of the payment operation, the terminal status STa of the self-service POS terminal 11 remains “1” indicating that the self-service POS terminal 11 is in operation, so that customers will not mistakenly think the self-service POS terminal 11 is available. A surveillance apparatus 23 that can properly conduct surveillance on the availability of the self-service POS terminals 11 can therefore be provided.

The surveillance apparatus 23 further provides the functions of the guiding unit 75. This function allows the surveillance apparatus 23 to use the monitors 30 installed in the waiting area Q to guide a customer waiting for settlement to an available self-service POS terminal 11. A customer waiting for settlement may therefore enter the payment area P in accordance with the information displayed on the monitors 30, operate an available self-service POS terminal 11 by himself/herself, and pay for the purchased commodities.

In addition, the surveillance apparatus 23 provides the functions of the checking unit 74, and provides different information depending on whether or not a customer is present in the waiting area Q. Specifically, when no customer is present in the waiting area Q, the surveillance apparatus 23 displays the image 32 shown in FIG. 11 on the monitors 30, whereas when a customer is present in the waiting area Q, the surveillance apparatus 23 displays the image 33 shown in FIG. 12 on the monitors 30. Note that when there is no available self-service POS terminal 11, the surveillance apparatus 23 displays the image 31 shown in FIG. 10 on the monitors 30 irrespective of whether or not a customer is present in the waiting area Q.

Customers in line in the waiting area Q can therefore recognize that there is no available self-service POS terminal 11 when the image 31 is displayed on the monitors 30. Thereafter, when a self-service POS terminal 11 becomes available, the image on the monitors 30 transitions from the image 31 to the image 33. The first customer waiting in line in the waiting area Q can therefore know that the self-service POS terminal 11 shown in the image 33 has become available. The customer may enter the operation region R of the self-service POS terminal 11 shown in the image 33 and make settlement for the commodities to be purchased.

At this point in time, when another self-service POS terminal 11 also becomes available approximately at the same time, different images are displayed on the monitors 30 depending on whether second and subsequent customers are present in the waiting area Q. That is, when a customer is present, the image 33 is displayed on the monitors 30 to guide the customer to the self-service POS terminal 11 having become available. In contrast, when no second or subsequent customers are in the waiting area Q, the image 32 is displayed on the monitors 30. Therefore, when second and subsequent customers are present in the waiting area Q, the image 33, which guides a customer to an available self-service POS terminal 11, can be continuously displayed also to those customers. On the other hand, when multiple customers are present in the waiting area Q, a list that allows identification of available self-service POS terminals 11 and unavailable self-service POS terminals 11 can be displayed on the monitors 30.

### Second Embodiment

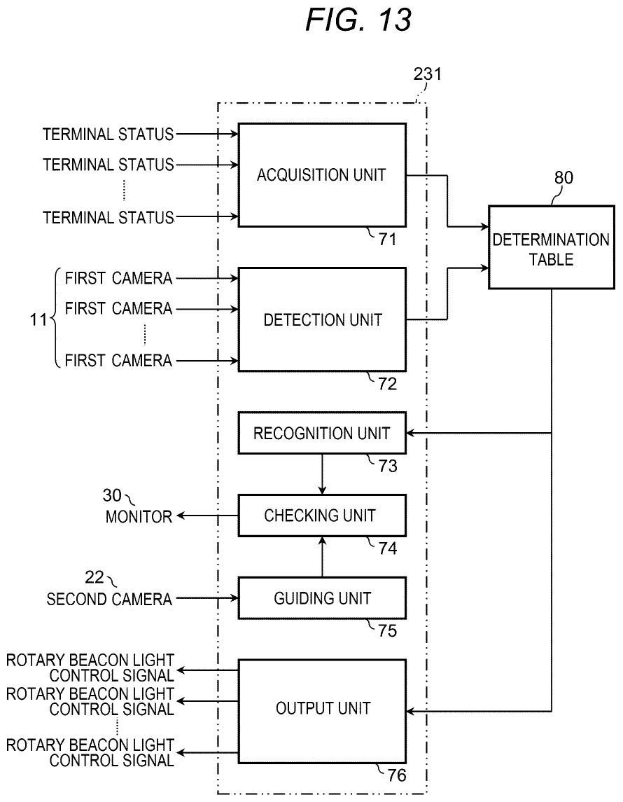

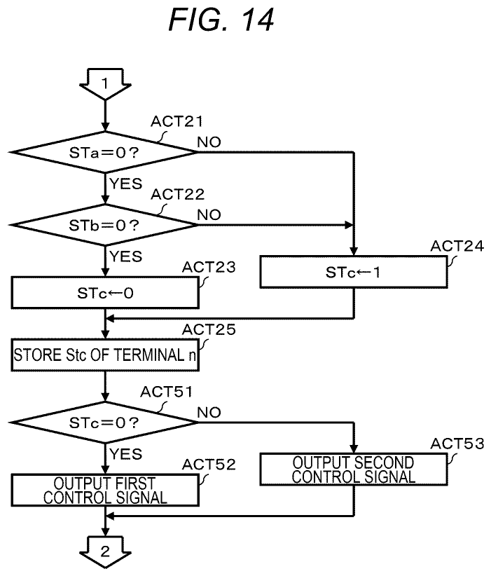

A second embodiment in which some functions are added to the surveillance apparatus 23 will be described with reference to FIGS. 13 and 14.

FIG. 13 is a diagrammatic view showing a primary functional configuration of the processor 231 of the surveillance apparatus 23 in the second embodiment. The processor 231 provides the described functions of an output unit 76 in addition to the functions as those described for the acquisition unit 71, the detection unit 72, the recognition unit 73, the checking unit 74, and the guiding unit 75 in the first embodiment.

The output unit 76 provides the function of outputting the result of the recognition made by the recognition unit 73. Specifically, the output unit 76 outputs a first rotary beacon light control signal to a self-service POS terminal 11 recognized by the recognition unit 73 as being available. The output unit 76 outputs a second rotary beacon light control signal to a self-service POS terminal 11 recognized by the recognition unit 73 as being unavailable. The first rotary beacon light control signal is, for example, a signal for turning on or flashing the rotary beacon light 65 in green. The second rotary beacon light control signal is, for example, a signal for turning on or flashing the rotary beacon light 65 in red.

FIG. 14 is a flowchart showing the procedure of the information processing performed by the processor 231 in accordance with instructions of the terminal surveillance program in the second embodiment. In general, FIG. 14 corresponds to the processing procedure described with reference to FIG. 8 in the first embodiment. However, in the second embodiment, the procedure after the process in ACT 25 differs from that in the first embodiment. For the second embodiment, the processes in ACT 1 to ACT 12 (in FIG. 7), the processes in ACT 21 to ACT 25 (in FIG. 8 and FIG. 14), and the processes in ACT 31 to ACT 41 (in FIG. 9) are the same as those in the first embodiment.

For the second embodiment, after ACT 12 in FIG. 7, having written the person status STb in the determination table 80, the processor 231 can be considered to proceed to ACT 21 in FIG. 14. The processor 231 then carries out the same processes as those in ACT 21 to ACT 25 already described with reference to FIG. 8. That is, the processor 231 checks the terminal status STa and the person status STb written in the determination table 80 for each self-service POS terminal 11 identified by a terminal number No. The processor 231 then recognizes that a self-service POS terminal 11 having the terminal status STa and the person status STb both being “0” is available. The processor 231 writes “0” in the determination table 80 as the availability status STc. In contrast, the processor 231 recognizes that a self-service POS terminal 11 having the terminal status STa and/or the person status STb being “1” is unavailable. The processor 231 writes “1” in the determination table 80 as the availability status STc.

The processor 231 having thus set the availability status STc of each of the self-service POS terminals 11 to “0” or “1” proceeds to ACT 51 in FIG. 14. The processor 231 checks as ACT 51 whether or not the availability status STc of a self-service POS terminal 11 is “0”.

When an availability status STc of a self-service POS terminal 11 is “0”, the processor 231 proceeds to ACT 52. The processor 231 outputs, as ACT 52, the first rotary beacon light control signal (first control signal) to the identified self-service POS terminal 11 with availability status STc of “0”. In contrast, when the availability status STc is “1” for a self-service POS terminal 11, the processor 231 proceeds to ACT 53. The processor 231 outputs, as ACT 53, the second rotary beacon light control signal (second control signal) to the identified self-service POS terminal 11.

Having output the first rotary beacon light control signal or the second rotary beacon light control signal, the processor 231 returns to ACT 3 (in FIG. 7). The processor 231 then carries out the processes in ACT 3 and subsequent in the same manner already described above.

The processor 231 realizes the described functions of the output unit 76 by carrying out the processes in ACT 51 to ACT 53.

In the second embodiment having the configuration described above, the output unit 76 outputs the first rotary beacon light control signal to a self-service POS terminal 11 recognized as being available by the recognition unit 73. As a result, the rotary beacon light 65 lights up or flashes in green in the self-service POS terminal 11. On the other hand, the output unit 76 outputs the second rotary beacon light control signal to a self-service POS terminal 11 recognized as being unavailable by the recognition unit 73. As a result, the rotary beacon light 65 lights up or flashes in red in the self-service POS terminal 11.

Therefore, according to the second embodiment, the color of the light emitted from the rotary beacon light provided at each of the self-service POS terminals 11 allows settlement makers and store clerks to readily identify whether the self-service POS terminal 11 is available or unavailable.

### OTHER EMBODIMENTS

The second embodiment is described with reference to an example in which the output unit 76 outputs the result of the recognition made by the recognition unit 73 as a rotary beacon light control signal to each of the self-service POS terminals 11 as appropriate. In another embodiment, the output unit 76 outputs data for showing different icons or images indicating the recognition result to the attendant terminal 14 as appropriate. The output data allows the attendant at the attendant terminal 14 to readily identify the available self-service POS terminals 11 and unavailable self-service POS terminals 11 based on the icons or images displayed on the display of the attendant terminal 14.

In an embodiment described above, self-service POS terminals 11 are used and monitored by the surveillance apparatus 23. In other store systems, commodity registration and settlement may be performed at separate terminals. For example, there is a store system in which customers register commodities by themselves via a smartphone carried by the customer or via a tablet terminal attached to a shopping cart. Once the customer has finished the registration of the commodities to be purchased, the customer proceeds to a dedicated settlement terminal to pay for the registered commodities. Such dedicated settlement terminals may be provided in place or in addition to the described self-service POS terminals 11, and, as such, be monitored by the surveillance apparatus 23 and the like.

There is also a store system in which a store clerk uses a dedicated registration machine to register commodities to be purchased by a customer, and then the customer uses a dedicated settlement terminal separated from the registration machine to make the settlement. The surveillance apparatus 23 in the present embodiment can also be used as a settlement terminal in a store system or a surveillance apparatus 23 may be integrated with a settlement terminal or the like.

An embodiment includes a display control apparatus 13 that captures the terminal status STa from each of the self-service POS terminals 11 and, in turn, provides the surveillance apparatus 23 with the terminal status Sta of each self-service POS terminal 11. However, in some examples, the attendant terminal 14 may capture the terminal status STa from each of the self-service POS terminals 11 and provide the surveillance apparatus 23 with the terminal status STa. In still other examples, the surveillance apparatus 23 may capture the terminal status STa directly from each of the self-service POS terminals 11 rather than via an intermediary device.

In a described example, the first cameras 21 are provided in one-to-one correspondence with the self-service POS terminals 11. In other examples, the first cameras 21 need not be provided in one-to-one correspondence with the self-service POS terminals 11. For example, a single first camera may be positioned to be capable of monitoring two adjacent self-service POS terminals 11, and the first camera 21 may provide images by which it can be determined whether a person is present at each.

In some examples, a person present in the operation region R of a self-service POS terminal 11 can be detected without use of an image from a first camera 21. For example, a person can be detected by using a human presence sensor such as an infrared light sensor or a weight sensor. The same applies to the second camera 22, which detects persons present in the waiting area Q. That is, persons present in the waiting area Q may be detected by using a human presence sensor or a weight sensor in place of the second camera 22.

### Third Embodiment

### Output of Payment Guidance Information on Payment Method Basis

The terminal surveillance system 200 is an example of an information processing system, the surveillance apparatus 23 is an example of an information processing server, the self-service POS terminals 11 are an example of a payment machine, and the secondary monitors 30S are an example of an information output apparatus. In the third embodiment, an example of output of payment guidance information from the surveillance apparatus 23 of terminal surveillance system 200 will be described. Note that the third embodiment can be realized as a combination with the first and second embodiments as appropriate, and that the basic hardware configurations in the third embodiment are the same as those shown in FIGS. 1, 2, and 4.

The self-service POS system 100 includes multiple self-service POS terminals 11 of different models. There are self-service POS terminals 11 of various models that differ on an available payment method basis. For example, there is a self-service POS terminal 11 that supports a single payment method and a self-service POS terminal 11 that supports two or more payment methods.

The self-service POS terminals 11 in this example include the following models:
Self-service POS terminals 11 (type AX), (type BX), and (type CX), each of which supports commodity registration during payment. In this context commodity registration during payment is the process of reading a commodity code or the like from a commodity with a scanner or the like and registering the commodity in the sales transaction at the self-service POS terminal 11.
Self-service POS terminals 11 (type AY), (type BY), and (type CY), each of which support commodity registration before payment. In this context, commodity registration before payment is the process of reading the commodity code or the like from a commodity at or with a communication terminal attached to a cart, a communication terminal provided in the store or the like, or the customer's own communication terminal, and registering the commodity in the sales transaction prior to arrival at the self-service POS terminal 11 for payment.
Self-service POS terminals 11 (type CZ), which supports both commodity registration during payment and commodity registration before payment.

In the present example, the self-service POS terminal 11 (type AX) supports commodity registration during payment and cash payment. The self-service POS terminal 11 (type BX) supports commodity registration during payment and cashless settlement. The self-service POS terminal 11 (type CX) supports commodity registration during payment with cash payment and cashless settlement.

The self-service POS terminal 11 (type AY) supports commodity registration before payment and cash payment. The self-service POS terminal 11 (type BY) supports commodity registration before payment and cashless settlement. The self-service POS terminal 11 (type CY) supports commodity registration before payment with cash payment and cashless settlement. The self-service POS terminals 11 (type AY), 11 (type BY), and 11 (type CY) are examples of settlement-only terminals.

The self-service POS terminal 11 (type CZ) supports commodity registration during payment with cash payment and cashless settlement, and also supports commodity registration before payment with cash payment and cashless settlement.

A business operator who wants to set up a payment area with a mixture of different terminal models installed may select two or more terminal models from the various terminal models described above. The possible terminal models of self-service POS terminals 11 used in the third embodiment are not limited to those described above.

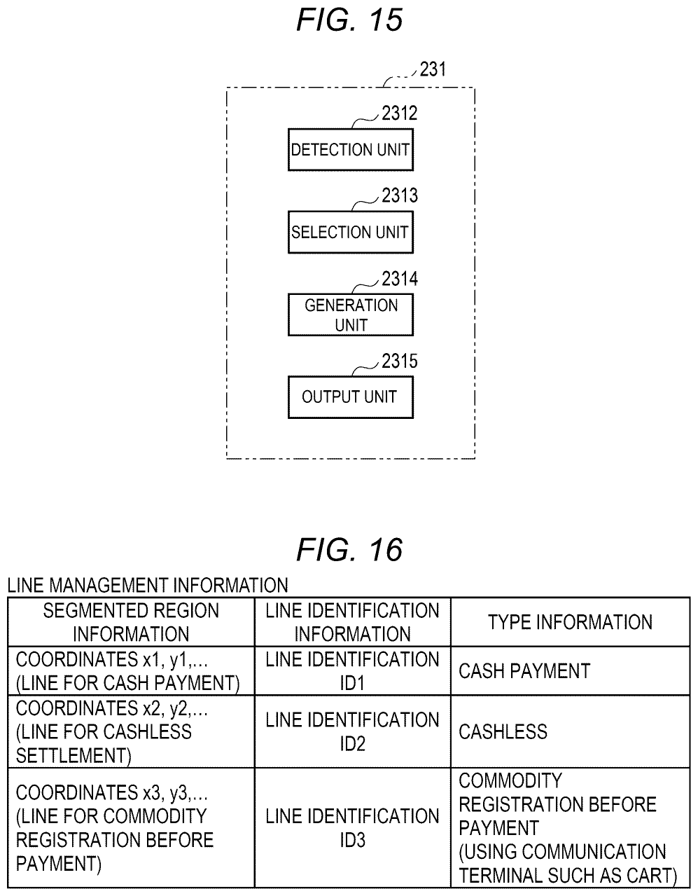

FIG. 15 is a diagrammatic view showing a primary functional configuration of the processor 231 of the surveillance apparatus 23.

The processor 231 is configured by software or the like to provide the described functions of a detection unit 2312, a selection unit 2313, a generation unit 2314, and an output unit 2315.

The detection unit 2312 detects, based on line management information used to assign a type to each line contained in the image data input by the second camera interface 237, the types of the lines contained in the image data and the line-up orders of users contained in the image data. Note that the users may be called customers.

The selection unit 2313 selects a self-service POS terminal 11 corresponding to the line in which a user having a predetermined line-up rank is in based on terminal management information used to manage identification information, the type, priority rank, and availability of each of the self-service POS terminals 11. The selection unit 2313 further selects a secondary monitor 30S corresponding to the user's line based on guidance management information used to manage the multiple secondary monitors 30S installed in correspondence with the different lines.

The generation unit 2314 generates the payment guidance information used to guide the user to the selected self-service POS terminal 11. For example, the payment guidance information includes the identification information used to identify the selected self-service POS terminal 11.

The output unit 2315 outputs the generated payment guidance information.

FIG. 16 shows an example of the line management information.

The main memory 232 or the auxiliary storage device 233 stores the line management information. The line management information is information for identifying the types corresponding to the lines contained in the image data. The line management information contains segmented region information for identifying a segmented region, line identification information for identifying a line, and type information according to a payment method. The detection unit 2312 detects multiple segmented regions from an image region contained in the image data based on the segmented region information. The detection unit 2312 detects a line from each of the segmented regions by using image recognition, identifies the line based on the line identification information, and identifies the type corresponding to the line based on the type information.

For example, the second camera 22 captures an image of an area in which users line up on a payment method basis. The second camera interface 237 receives the image data from the second camera 22. The image region contained in the image data contains the lines in which the users line up on a payment method basis. For example, when the users line up in three lines in accordance with three payment methods (cash payment, cashless settlement, and commodity registration before payment) coordinate values that specify three segmented regions can be set so each line is in a different segmented region. For example, a clerk or manager sets the coordinate values that specify the three segmented regions while viewing images from the second camera 22.

The detection unit 2312 detects and identifies the three lines contained in the three segmented regions based on the line identification information, and identifies a first line as a line for cash payment, the second line as a line for cashless settlement, and a third line as a line for commodity registration before payment.

In other examples, a second camera 22 may be provided on a per line basis, and the line management information may be used to manage the information from the second cameras 22 and the payment types in association with each other. For example, the line management information associates image data from the second camera 22 installed in correspondence with the first line with cash payment, associates image data from the second camera 22 installed in correspondence with the second line with cashless settlement, and associates image data from the second camera 22 installed in correspondence with the third line with commodity registration before payment.

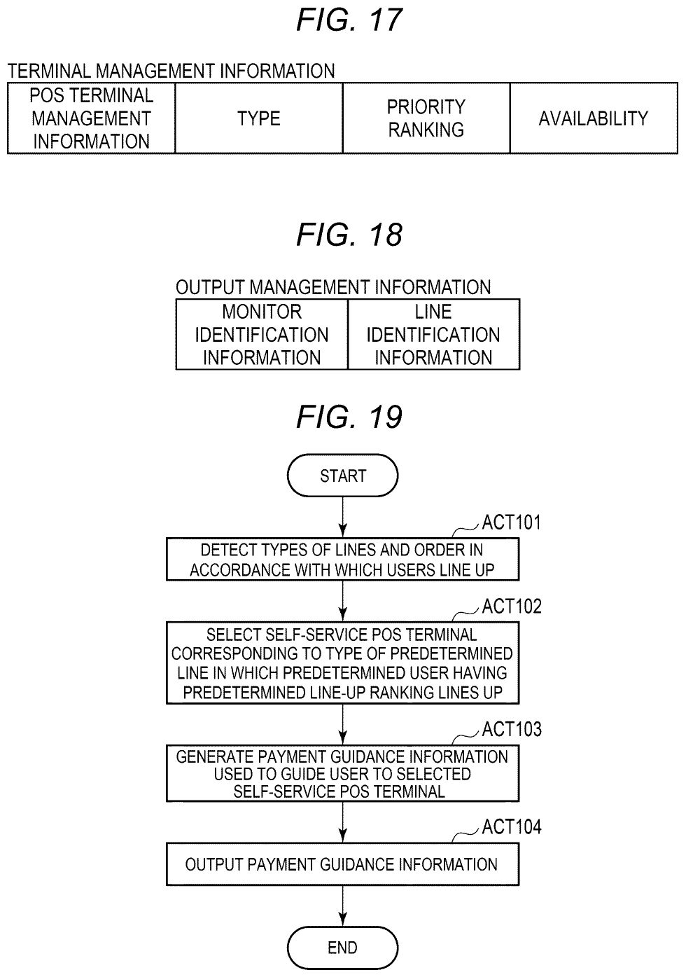

FIG. 17 shows an example of the terminal management information.

The main memory 232 or the auxiliary storage device 233 stores the terminal management information. The terminal management information contains POS terminal identification information, a type, a priority rank, and availability of each of the self-service POS terminals 11. The POS terminal identification information is, for example, an identification number unique to each of the self-service POS terminals 11. The type indicates, for example, a payment method. The priority rank is assigned on a payment method basis. The availability indicates whether or not the self-service POS terminal 11 is available. Whether or not the self-service POS terminal 11 is available is detected by the approach described in the first and second embodiments.

FIG. 18 shows an example of the output management information.

The main memory 232 or the auxiliary storage device 233 stores the output management information. For example, the multiple secondary monitors 30S are installed in correspondence with the lines. The output management information manages information output to the secondary monitors 30S. The output management information contains the combination of monitor identification information for identifying the secondary monitors 30S and the line identification information for identifying the lines. For example, based on the output management information, the secondary monitor 30S installed in correspondence with the appropriate line is selected as the destination to which information is output.

In other examples, only one secondary monitor 30S may for all the lines, and the display region of the single secondary monitor 30S may be divided into multiple display regions, and the single secondary monitor 30S may display information in the segmented display regions for each of the different lines. In this case, the output management information manages the information displayed in the segmented display regions. Replacing the monitor identification information shown in FIG. 18 with segmented display region identification information allows the output management information to associate the segmented display regions with the appropriate lines so that the information displayed in each of the segmented display regions can be managed.

FIG. 19 is a flowchart showing an example of the payment guidance information output by the surveillance apparatus 23.

The second camera interface 237 of the surveillance apparatus 23 receives the image data from the second camera 22, as shown in FIG. 19. The second camera interface 237 is an example of the input interface. The second camera 22 captures an image of a region containing the lines in which the users line up on a payment method basis.

The detection unit 2312 detects, based on the line management information that assigns the types to the lines contained in the image data input by the second camera interface 237, the types of the lines contained in the image data and the line-up orders of the users contained in the image data (ACT 101).

The selection unit 2313 selects a self-service POS terminal 11 corresponding to the type of the line in which the user having the predetermined line-up rank is in based on the terminal management information that tracks the identification information, type, priority rank, and availability of each of the self-service POS terminals 11 (ACT 102).

The generation unit 2314 generates the payment guidance information used to guide the users to the selected self-service POS terminal 11 (ACT 103). The payment guidance information includes the POS terminal identification information that identifies the selected self-service POS terminal 11 for the user.

The output unit 2315 outputs the generated payment guidance information (ACT 104).

For example, when the line of the user having a first line-up rank (e.g., the user who was the first lined up among users presently in all lines) corresponds to cash payment, the selection unit 2313 selects a self-service POS terminal 11 having the highest priority rank out of available payment machines of the type that accepts cash payment. The generation unit 2314 generates the payment guidance information used to guide the user to the selected self-service POS terminal 11. The selection unit 2313 selects the secondary monitor 30S corresponding to the user's line based on the output management information. The monitor interface 238 outputs a video signal relating to the payment guidance information to the secondary monitor 30S corresponding to the user's line. The monitor interface 238 is an example of an output interface.

When the line of the user having the first line-up rank corresponds to cashless settlement, the selection unit 2313 selects the self-service POS terminal 11 having the highest priority rank out of available payment machines of the type that accepts cashless settlement. The generation unit 2314 generates the payment guidance information used to guide the user to the selected self-service POS terminal 11. The selection unit 2313 selects the secondary monitor 30S corresponding to the user's line based on the output management information. The monitor interface 238 outputs a video signal relating to the payment guidance information to the secondary monitor 30S corresponding to the user's line.

When the line of the user having the first line-up rank corresponds to commodity registration during payment, the selection unit 2313 selects the self-service POS terminal 11 having the highest priority rank out of available payment machines of the type corresponding to commodity registration during payment. The generation unit 2314 generates the payment guidance information used to guide the user to the selected self-service POS terminal 11. The selection unit 2313 selects the secondary monitor 30S corresponding to the user's line based on the output management information. The monitor interface 238 outputs a video signal relating to the payment guidance information to the secondary monitor 30S corresponding to the user's line.

When the line of the user having the first line-up rank corresponds to commodity registration before payment, the selection unit 2313 selects the self-service POS terminal 11 having the highest priority rank out of available payment machines of the type corresponding to commodity registration before payment. The generation unit 2314 generates the payment guidance information used to guide the user to the selected self-service POS terminal 11. The selection unit 2313 selects the secondary monitor 30S corresponding to the user's line based on the output management information. The monitor interface 238 outputs a video signal relating to the payment guidance information to the secondary monitor 30S corresponding to the user's line.

The input interface 301 of the secondary monitor 30S receives the video signal relating to the payment guidance information, and the display 302 displays the payment guidance information based on the video signal.

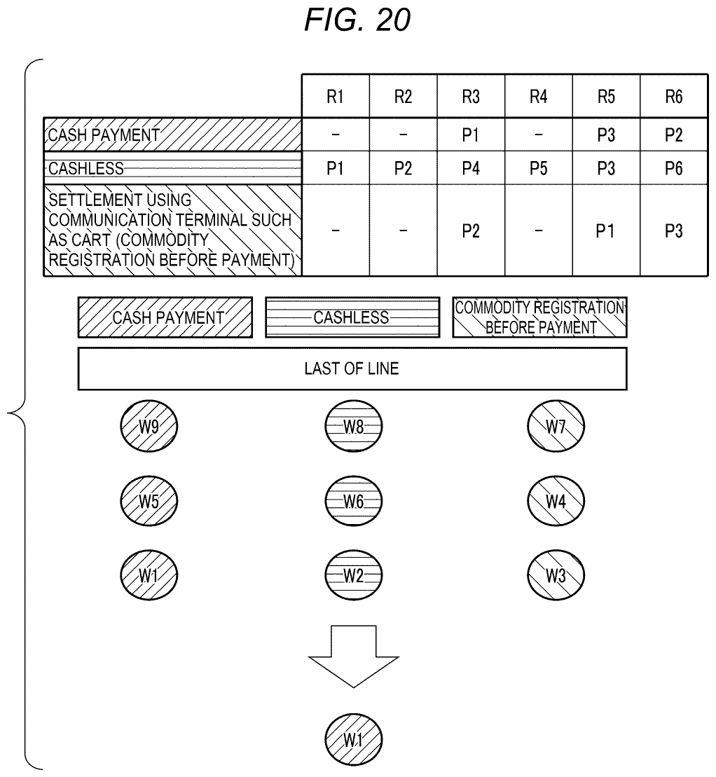

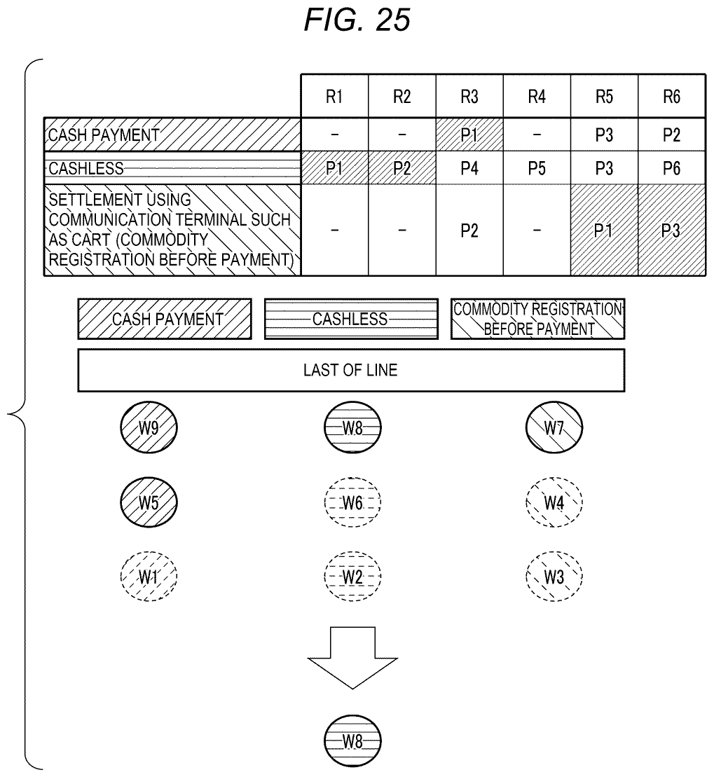

FIGS. 20 to 25 are transition diagrams for illustrating different payment type lines and the guidance to a self-service POS terminal 11. In FIGS. 20 to 25, a scenario in which users can line up in three different lines in accordance with the three payment methods (cash payment, cashless settlement, and commodity registration before payment) is described. In this example, no distinction is made in the established lines between a cashless payment for already registered items or a cash payment for already registered items. The users lined up in the three lines sequentially move to the self-service POS terminals 11 in accordance with the payment guidance information displayed on the secondary monitors 30S. As users go to the directed self-service POS terminals 11, the customer lines transition in sequence from those shown in FIG. 20 to those shown in FIG. 25.

The detection unit 2312 detects the types of the lines and the line orders of the users in the image data based on the line management information, as shown in FIG. 20. For example, the detection unit 2312 identifies, from left to right, a first line as a line for cash payment, a second line as a line for cashless settlement, and a third line as a line for users who already performed commodity registration before arriving at the payment area P (“commodity registration before payment”). The detection unit 2312 further detects or identifies users with a first rank W1 through a ninth rank W9. In this context, the first rank W1 indicates that the user was the first (in time) lined up to wait for payment among users in all the three lines. The ninth rank W9 indicates that the user was the last (in time) lined up to wait for payment among users in all the three lines.

For example, the detection unit 2312 detects the first rank W1, the fifth rank W5, and the ninth rank W9 sequentially from the front of the line for cash payment. The detection unit 2312 further detects the second rank W2, the sixth rank W6, and the eighth rank W8 sequentially from the front of the line for cashless settlement. The detection unit 2312 still further detects the third rank W3, the fourth rank W4, and the seventh rank W7 sequentially from the front of the line for commodity registration before payment.

In the following description, the available self-service POS terminals 11 are called cash registers R1 to R6. The terminal identification information, type, priority rank, and availability of the cash registers R1 to R6 are managed as terminal management information. The cash registers R1, R2, and R4 support the payment method types “commodity registration during payment” and “cashless settlement.” The cash registers R3, R5, and R6 support the payment method types “commodity registration during payment,” “cash payment,” and “cashless settlement,” and also supports payment method types “commodity registration before payment,” “cash payment,” and “cashless settlement.”

As seen in FIG. 20, when commodity registration during payment and cash payment are being selected, first priority P1 is assigned to the cash register R3, second priority P2 is assigned to the cash register R6, and third priority P3 is assigned to the cash register R5. When commodity registration during payment and cashless settlement are being selected, the first priority P1 is assigned to the cash register R1, the second priority P2 is assigned to the cash register R2, the third priority P3 is assigned to the cash register R5, fourth priority P4 is assigned to the cash register R3, fifth priority P5 is assigned to the cash register R4, and sixth priority P6 is assigned to the cash register R6. When commodity registration before payment (e.g., registration was by smartphone or cart terminal), then for cash payment or cashless settlement, the first priority P1 is assigned to the cash register R5, the second priority P2 is assigned to the cash register R3, and the third priority P3 is assigned to the cash register R6.

The selection unit 2313 selects a self-service POS terminal 11 corresponding to the type of line in which the user is in when at the front of the respective line and with appropriate rank. The selection is made based on the terminal management information. For example, the selection unit 2313 selects one of the cash registers R3, R5, and R6 for the user having the first rank W1 since this user in the cash payment line. The selection unit 2313 further selects an available cash registers from the cash registers R3, R5, and R6, based on the established priority and thus selects the cash register R3 having the highest priority from the selected cash registers for the user with the first rank W1.

The generation unit 2314 generates the payment guidance information for guiding this user (with first rank W1) to the selected cash register R3. The payment guidance information contains the POS terminal identification information (terminal number, for example) that identifies the selected cash register R3. Note that the payment guidance information may be information for guiding a user waiting in line for payment to a cash register where the user should make payment or information used by a store clerk to tell a user waiting in line for payment which register to go to for making payment. The payment guidance information may contain a layout map of multiple cash registers, and the layout map may contain the POS terminal identification information that identifies the selected register R3. The selection unit 2313 selects the secondary monitor 30S corresponding to the first line (cash payment line) based on the output management information.

The output unit 2315 sends the generated payment guidance information to the secondary monitor 30S corresponding to the first line. The secondary monitor 30S corresponding to the first line displays the payment guidance information.

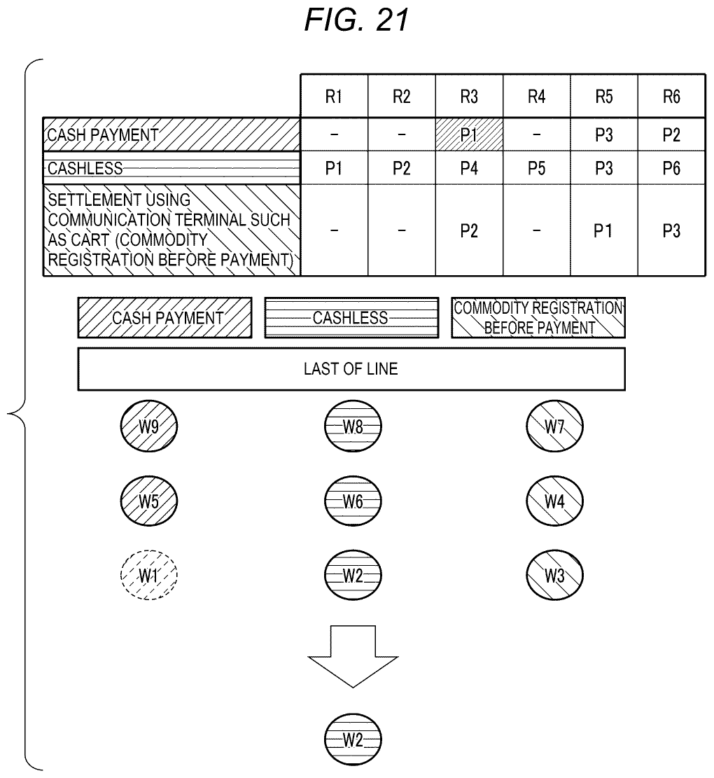

The user having the first rank W1 follows the guidance to the cash register R3 contained in the payment guidance information displayed on the secondary monitor 30S, goes to the cash register R3, and makes payment at the cash register R3. The lineups in the lines transition from those in FIG. 20 to those in FIG. 21.

The selection unit 2313 subsequently selects the cash registers R1 to R6 corresponding to the type of the second line for cashless settlement where the user having the second rank W2 lines up, as shown in FIG. 21. The selection unit 2313 further selects available cash registers from the selected cash registers R1 to R6, and selects the cash register R1 having the highest priority from the selected cash registers.

The generation unit 2314 generates the payment guidance information for guiding the user to the selected cash register R1. The selection unit 2313 selects the secondary monitor 30S corresponding to the second line based on the output management information.

The output unit 2315 outputs the generated payment guidance information to the secondary monitor 30S corresponding to the second line. The secondary monitor 30S corresponding to the second line displays the payment guidance information.

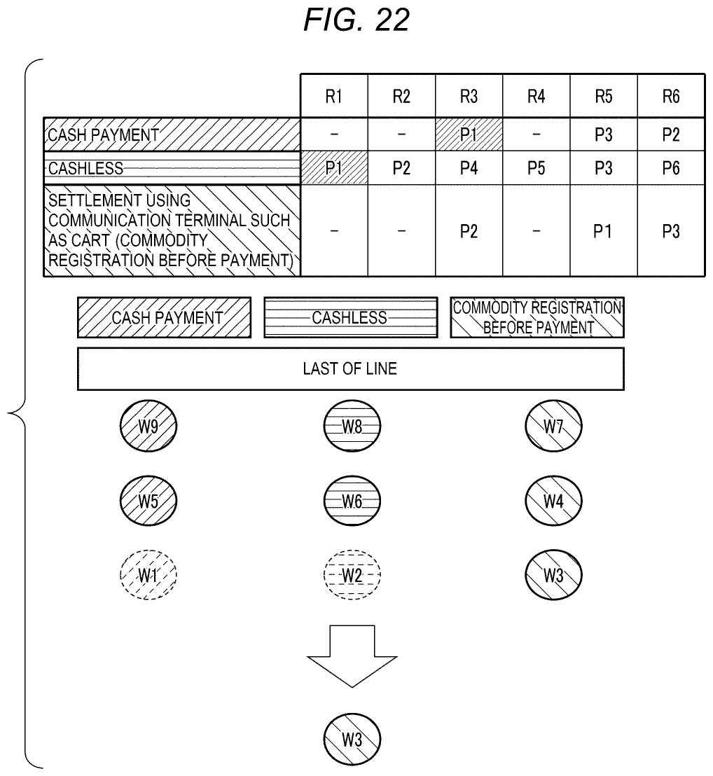

The user having the second rank W2 receives the guidance contained in the payment guidance information displayed on the secondary monitor 30S, goes to the cash register R1 accordingly, and makes payment at the cash register R1. The lines transition from those in FIG. 21 to those in FIG. 22.

The selection unit 2313 subsequently selects the cash registers R3, R5, and R6 corresponding to the type of the third line for commodity registration before payment where the user having the third rank W3 lines up, as shown in FIG. 22. The selection unit 2313 further selects the cash registers R5 and R6 that are available from the selected cash registers, and selects the cash register R5 having the highest priority from the selected cash registers.

The generation unit 2314 generates the payment guidance information for guiding the user to the selected cash register R5. The selection unit 2313 selects the secondary monitor 30S corresponding to the third line based on the output management information.

The output unit 2315 outputs the generated payment guidance information to the secondary monitor 30S corresponding to the third line. The secondary monitor 30S corresponding to the third line displays the payment guidance information.

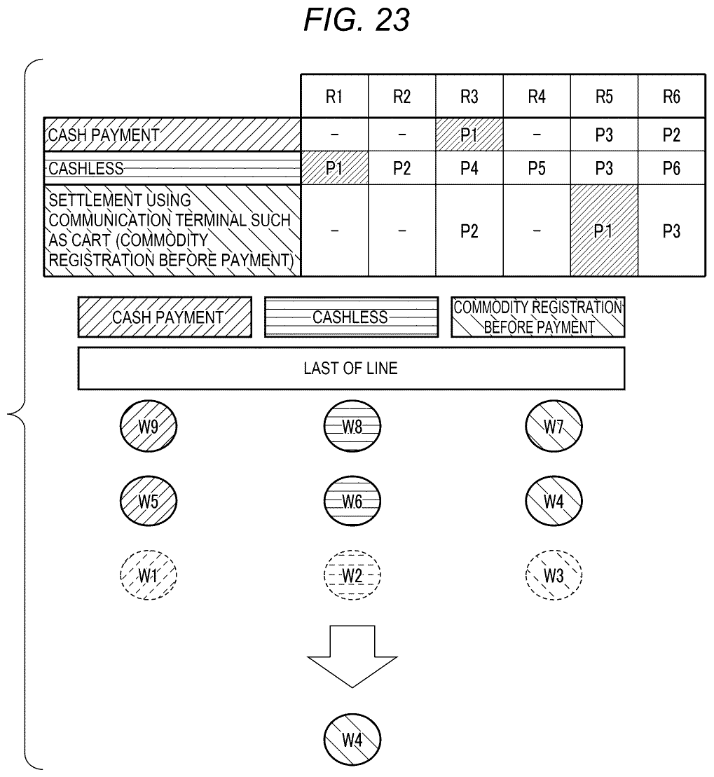

The user having the third rank W3 receives the guidance contained in the payment guidance information displayed on the secondary monitor 30S, goes to the cash register R5 accordingly, and makes payment at the cash register R5. The lines transition from those in FIG. 22 to those in FIG. 23.

The selection unit 2313 subsequently selects among the cash registers R3, R5, and R6 for commodity registration before payment where the user having the fourth rank W4 lines up, as shown in FIG. 23. The selection unit 2313 selects the cash register R6 that is available from the cash registers. In this case, there is only one available cash register, so the priority levels among cash registers R3, R5, and R6 is not specifically taken into consideration.

The generation unit 2314 generates the payment guidance information for guiding the user to the selected cash register R6. The selection unit 2313 selects the secondary monitor 30S corresponding to the third line based on the output management information.

The output unit 2315 outputs the generated payment guidance information to the secondary monitor 30S corresponding to the third line. The secondary monitor 30S corresponding to the third line displays the payment guidance information.

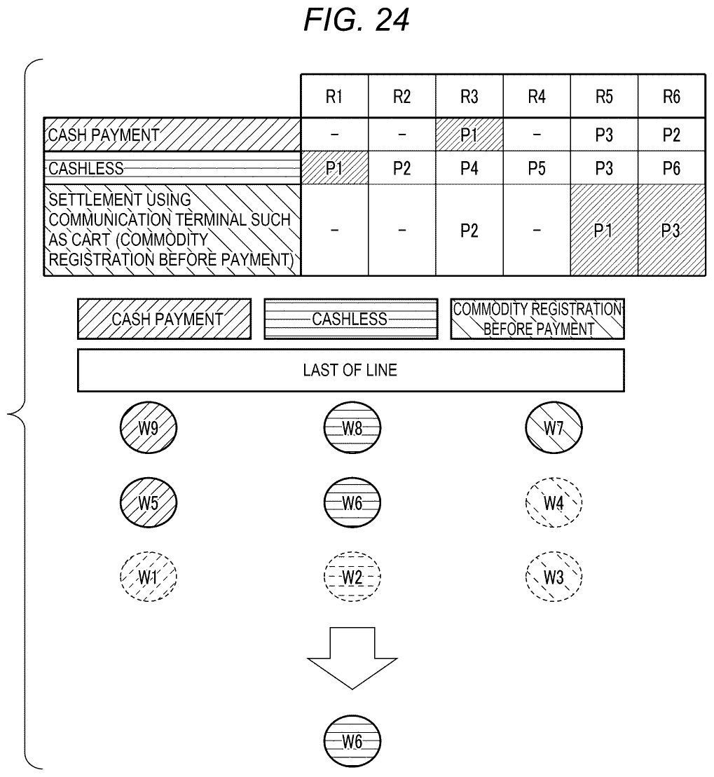

The user having the fourth rank W4 follows the guidance contained in the payment guidance information displayed on the secondary monitor 30S, goes to the cash register R6 accordingly, and makes payment at the cash register R6. The lines transition from those in FIG. 23 to those in FIG. 24.

The selection unit 2313 next attempts to select among the cash registers R3, R5, and R6 corresponding to the first line (cash payment) where the user having the fifth rank W5 lines up, but as there are no available cash registers among the cash registers R3, R5, and R6, as shown in FIG. 24. The selection unit 2313 then selects among the cash registers R1 to R6 corresponding to the second line (cashless settlement) where the user having the sixth rank W6 lines up. The selection unit 2313 selects between cash registers R2 and R4 that are presently available, and thus selects the cash register R2 having the higher priority from the available cash registers for cashless settlement.

The generation unit 2314 generates the payment guidance information for guiding the user to the selected cash register R2. The selection unit 2313 selects the secondary monitor 30S corresponding to the second line based on the output management information.

The output unit 2315 outputs the generated payment guidance information to the secondary monitor 30S corresponding to the second line. The secondary monitor 30S corresponding to the second line displays the payment guidance information.

The user having the sixth rank W6 follows the guidance contained in the payment guidance information displayed on the secondary monitor 30S, goes to the cash register R2 accordingly, and makes payment at the cash register R2. The lines transition from those in FIG. 24 to those in FIG. 25.

Since still no cash register is available for the user having the rank W5, the selection unit 2313 next attempts to select among cash registers R3, R5, and R6 corresponding to the third line (commodity registration before payment) where the user having the rank seventh W7 lines up, but there are no available cash registers for this payment type either among the cash registers R3, R5, and R6, as shown in FIG. 25. Thus, the selection unit 2313 then selects among the cash registers R1 to R6 corresponding to the second line (cashless settlement) where the user having the eighth rank W8 lines up. The selection unit 2313 selects the cash register R4 that is the only available from the cash registers appropriate for the second line.

The generation unit 2314 generates the payment guidance information for guiding the user to the selected cash register R4. The selection unit 2313 selects the secondary monitor 30S corresponding to the second line based on the output management information.

The output unit 2315 outputs the generated payment guidance information to the secondary monitor 30S corresponding to the second line. The secondary monitor 30S corresponding to the second line displays the payment guidance information.

The user having the eighth rank W8 follows the guidance contained in the payment guidance information displayed on the secondary monitor 30S, goes to the cash register R4 accordingly, and makes payment at the cash register R4.

In addition to the cash registers R1 to R6 described above, another cash register of a type which supports commodity registration before payment settlements by cash or cashless methods, but does not support commodity registration during payment, may be added. Such a cash register type is an example of a terminal dedicated to settlement and may be referred to in some instances as payment kiosk or the like. The selection unit 2313 may preferentially select such a payment kiosk or cash register for the users in the third line. When a payment kiosk type cash register is not available, the selection unit 2313 can select among the cash registers R3, R5, and R6. In some examples, a cash register dedicated to settlement only (no registration processing), can be assigned for those users who register commodities before payment. The users who register commodities before payment may therefore be more efficiently handled, contributing to shortening of wait times.

The above example describes the case where the payment guidance information is output directly to customer, but in other examples the payment guidance information may be output to store clerks who then guide or direct the customers accordingly. In this case, the surveillance apparatus 23 changes the destination to which the payment guidance information is output from the secondary monitors 30S to the attendant terminal 14, and outputs the payment guidance information to the attendant terminal 14.

The monitor of the attendant terminal 14 can have segmented screen regions corresponding to the established lines to display the payment guidance information for each line. The secondary monitors 30S installed in correspondence with the lines may then be omitted. For example, a first segmented region corresponding to the first line contains the payment guidance information for users in the first line, and a store clerk looks at the payment guidance information in the first segmented region and guides a user in the first line to a selected self-service POS terminal 11. The surveillance apparatus 23 thus outputs the payment guidance information for the store clerks and allows the store clerks to assist in guiding the users to the appropriate self-service POS terminals 11.

The third embodiment will be summarized below.

(1) The surveillance apparatus 23, which is an information processing server, detects the types of the lines contained in the image data and the line-up orders of the users contained in the image data based on the line management information. The surveillance apparatus 23 selects a self-service POS terminal 11 corresponding to the type of line in which the user having the highest current line-up rank based on the payment machine management information. The surveillance apparatus 23 generates the payment guidance information for guiding the user to the selected self-service POS terminal 11. The surveillance apparatus 23 outputs the generated payment guidance information, for example, to one of the monitors 30.

The payment guidance information is generated based on the payment machine management information, which tracks the register type, priority ordering, and current availability of each of the self-service POS terminals 11. The surveillance apparatus 23 can thus output payment guidance information that provides an improvement in operation efficiency of the multiple self-service POS terminals 11.

(2) When the line of the user having the first line-up rank corresponds to cash payment, the surveillance apparatus 23 selects the self-service POS terminal 11 having the highest priority rank out of available self-service POS terminals 11 designated as being a type that accepts cash payment. When the line of the user having the first line-up rank corresponds to cashless settlement, the surveillance apparatus 23 selects the self-service POS terminal 11 having the highest priority rank out of available self-service POS terminals 11 designated as being a type that accepts cashless settlement.

The user can thus be guided to a self-service POS terminal 11 of a model/type suitable for the desired payment method (cash payment or cashless settlement).

(3) When the line of the user having the first line-up rank corresponds to a type for commodity registration during payment, the surveillance apparatus 23 selects the self-service POS terminal 11 having the highest priority rank out of available self-service POS terminals 11 designated as being of the type permitting commodity registration during payment. When the line of the user having the first line-up rank corresponds to a type for commodity registration before payment, the surveillance apparatus 23 selects the self-service POS terminal 11 having the highest priority rank out of available payment machines designated as being a type for handling transaction involving commodity registration before payment (e.g., registration via smartphone shopping application or a cart based terminal).

The user can thus be guided to a self-service POS terminal 11 of a model/type suitable for handling either commodity registration during payment or commodity registration before payment) for the user.

(4) The surveillance apparatus 23 selects a secondary monitor 30S corresponding to the appropriate line based on the output management information that keeps track of the multiple secondary monitors 30S installed in correspondence with the established lines, and outputs the payment guidance information to a secondary monitor 30S accordingly. The payment guidance information includes or provides identification information that identifies the self-service POS terminal 11 that has been selected for the user.

A user waiting in line can thus identify the self-service POS terminal 11 that has been selected from the information displayed on the secondary monitor 30S and smoothly make payment at the appropriate self-service POS terminal 11.

A software program or the like according to an embodiment may be prestored in an electronic component of the system, or may be transferred from the electronic components of the system. In the latter case, a program in an executable or installable format may be transferred via a network or on a storage medium. The storage medium may be a non-transitory, tangible medium. The storage medium is a computer-readable medium. The storage medium may be a medium in any form that can store a program and can be read by a computer, such as an optical disk or a memory card. A program may be transferred or provided via a network.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A surveillance apparatus, comprising:
a communication interface;
a storage unit;
an output interface connectable to an output unit in a checkout waiting area;
a first camera interface connectable to a first camera;
a second camera interface connectable to a second camera; and
a processor configured to:
identify whether customers are waiting in any of a plurality of different lines established in the checkout waiting area for different settlement types based on an image of the checkout waiting area received via the second interface from the second camera;
identify whether any of a plurality of checkout terminals in a checkout area are available based on status notifications received via the communication interface for the plurality of checkout terminals and images received via the first interface from a first camera associated with each of the plurality of checkout terminals;
when a checkout terminal is identified as available, select a line of the plurality of different lines when preset information stored in the storage unit indicates a settlement type available at the identified checkout terminal corresponds to the settlement type for which the line is established; and
output guidance information via the output interface to indicate a customer in the selected line should proceed to the checkout terminal identified as available.

2. The surveillance apparatus according to claim 1, wherein the preset information contains priority ranks for the plurality of checkout terminals within each settlement type corresponding to the plurality of different lines.

3. The surveillance apparatus according to claim 1, wherein
the processor is further configured to:
identify which customer in the plurality of different lines has been waiting the longest among all customers in the checkout waiting area, and
the line is selected based additionally on customer waiting time.

4. The surveillance apparatus according to claim 3, wherein the processor identifies which customer in the plurality of different lines has been waiting the longest based on images from the second camera.

5. The surveillance apparatus according to claim 1, wherein the output interface is a monitor interface connected to a plurality of monitors in the checkout waiting area.

6. The surveillance apparatus according to claim 1, wherein the processor is further configured to identify a correspondence between the different settlement types and the plurality of different lines established in the checkout waiting area based on predetermined correspondence information stored in the storage unit indicating regions in the checkout waiting area depicted in images from the second camera.

7. The surveillance apparatus according to claim 1, wherein
the first camera interface is connected to a plurality of first cameras in a checkout area, each first camera being positioned to respectively image operations at one the plurality of checkout terminals in the checkout area.

8. The surveillance apparatus according to claim 7, wherein the second camera interface is connected to the second camera.

9. The surveillance apparatus according to claim 1, wherein
the communication interface is connected to a display control apparatus which is connected to the plurality of checkout terminals, and
the display control apparatus provides the status notifications from the plurality of checkout terminals.

10. The surveillance apparatus according to claim 1, wherein the different settlement types include registration followed by cash settlement, registration followed by cashless settlement, and settlement of already registered items.

11. A store settlement system, comprising:
a checkout waiting area with a plurality of different line regions for different settlement types;
a plurality of monitors in the checkout waiting area, one monitor in the plurality of monitors for each of the plurality of different line regions;
a checkout area with a plurality of checkout terminals, the plurality of checkout terminals being set for a mix of different settlement types;
a plurality of first cameras, each first camera being associated with one of the plurality of checkout terminals and positioned to image operations at the associated one of the plurality of checkout terminals;
a second camera positioned to image the checkout waiting area;
a surveillance apparatus including:
a communication interface;
a storage unit;
an output interface connected to the plurality of monitors;
a first camera interface connected to the plurality of first cameras;
a second camera interface connected to the second camera; and
a processor configured to:
identify whether customers are waiting in any of a plurality of different line regions in the checkout waiting area based on an image of the checkout waiting area received via the second interface from the second camera;
identify whether any of the plurality of checkout terminals are available based on status notifications received via the communication interface for the plurality of checkout terminals and images received via the first interface from the plurality of first cameras;
when a checkout terminal is identified as available, select a line region of the plurality of different line regions when preset information stored in the storage unit indicates a settlement type available at the identified checkout terminal corresponds to the settlement type of the line region; and
output guidance information via the output interface to one of the plurality of monitors to indicate a customer in the selected line region should proceed to the checkout terminal identified as available.

12. The store settlement system according to claim 11, wherein the preset information contains priority ranks for the plurality of checkout terminals within each settlement type corresponding to the plurality of different line regions.

13. The store settlement system according to claim 11, wherein
the processor is further configured to:
identify which customer in the plurality of different line regions has been waiting the longest among all customers in the checkout waiting area, and
the line region is selected based additionally on customer waiting time.

14. The store settlement system according to claim 13, wherein the processor identifies which customer in the plurality of different line regions has been waiting the longest based on images from the second camera.

15. The store settlement system according to claim 11, wherein the processor is further configured to identify a correspondence between the different settlement types and the plurality of different line regions in the checkout waiting area based on predetermined correspondence information stored in the storage unit indicating regions in the checkout waiting area depicted in images from the second camera.

16. The store settlement system according to claim 11, wherein
the communication interface is connected to a display control apparatus which is connected to the plurality of checkout terminals, and
the display control apparatus provides the status notifications from the plurality of checkout terminals.

17. The store settlement system according to claim 11, wherein the different settlement types include registration followed by cash settlement, registration followed by cashless settlement, and settlement of already registered items.

18. A non-transitory, computer-readable medium storing program instructions which when executed by a processor of a surveillance apparatus in a store settlement system cause the apparatus to perform a method comprising:
identify whether customers are waiting in any of a plurality of different lines established in a checkout waiting area for different settlement types based on an image of the checkout waiting area received from a second camera;
identify whether any of a plurality of checkout terminals in a checkout area are available based on status notifications received via a communication interface for the plurality of checkout terminals and images received via from a first camera associated with each of the plurality of checkout terminals;
when a checkout terminal is identified as available, select a line of the plurality of different lines when preset information indicates a settlement type available at the identified checkout terminal corresponds to the settlement type for which the line is established; and
output guidance information via an output interface to indicate a customer in the selected line should proceed to the checkout terminal identified as available.

19. The medium according to claim 18, wherein the preset information contains priority ranks for the plurality of checkout terminals within each settlement type corresponding to the plurality of different lines.

20. The medium according to claim 18, the method further comprising:
identify which customer in the plurality of different lines has been waiting the longest among all customers in the checkout waiting area, and
the line is selected based additionally on customer waiting time.
